(19) United States
(12) Patent Application Publication
(10) Pub. No.: US 2023/0087152 A1
(43) Pub. Date: Mar. 23, 2023

(54) COMPUTER-READABLE RECORDING MEDIUM STORING PROGRAM AND INFORMATION PROCESSING METHOD

(71) Applicant: FUJITSU LIMITED, Kawasaki-shi (JP)

(72) Inventor: MASAKI ARAI, Kawasaki (JP)

(73) Assignee: FUJITSU LIMITED, Kawasaki-shi (JP)

(21) Appl. No.: 17/840,667

(22) Filed: Jun. 15, 2022

(30) Foreign Application Priority Data
Sep. 22, 2021 (JP) 2021-153696

(51) Int. Cl. G06F 8/41

(52) U.S. Cl. CPC G06F 8/445; G06F 8/452; G06F 8/433

(57) ABSTRACT

A recording medium stores a program for generating a source code that indicates processing on a sparse matrix and for causing a computer to execute a process including: acquiring second codes by optimizing, with a convex polyhedral model, a first code in which loop processing on a matrix is written in a static control part format; converting the second codes into source code candidates, based on sparse matrix information that indicates a variable that represents a non-zero element of the sparse matrix, expression information that indicates an operation expression that corresponds to a function included in the second codes, and data type information that indicates a type to be used for the variable; and selecting the source code from among the source code candidates in accordance with evaluation of processing performance for the sparse matrix in a case where each of the source code candidates is used.

### CROSS-REFERENCE TO RELATED APPLICATION

This application is based upon and claims the benefit of priority of the prior Japanese Patent Application No. 2021-153696, filed on Sep. 22, 2021, the entire contents of which are incorporated herein by reference.

### FIELD

The embodiments discussed herein are related to a computer-readable recording medium storing a program and an information processing method.

### BACKGROUND

A hotspot of a program tends to be limited in High Performance Computing (PC) applications. For example, even in a case where profile data is obtained to capture features of the program, it is often sufficient to examine only some loops (kernel loops). Kernel loops of HPC applications usually access a large amount of data. To execute the kernel loops at high speed, the effective use of a cache of a central processing unit (CPU) is attempted.

Japanese Laid-open Patent Publication No. 2007-66128, International Publication Pamphlet No. WO 2017/216858, U.S. Patent Application Publication No. 2019/0278593, and U.S. Patent Application Publication No. 2009/0307673 are disclosed as related art.

Cohen and two others, “A Polyhedral Approach to Ease the Composition of Program Transformations”, Euro-Par 2004: Euro-Par 2004 Parallel Processing, pp. 292-303, European Conference on Parallel Processing 2004, is also disclosed as related art.

### SUMMARY

According to an aspect of the embodiments, a non-transitory computer-readable recording medium stores a program for generating a source code that indicates processing on a sparse matrix and for causing a computer to execute a process including: acquiring a plurality of second codes by optimizing, with a convex polyhedral model, a first code in which loop processing on a matrix is written in a static control part format; converting the plurality of second codes into a plurality of source code candidates, based on sparse matrix information that indicates a variable that represents a non-zero element of the sparse matrix, expression information that indicates an operation expression that corresponds to a function included in the second codes, and data type information that indicates a type to be used for the variable; and selecting the source code from among the plurality of source code candidates in accordance with evaluation of processing performance for the sparse matrix in a case where each of the plurality of source code candidates is used.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for describing an information processing apparatus according to a first embodiment;

FIG. 2 is a diagram illustrating an example of hardware of an information processing apparatus according to a second embodiment;

FIG. 3 is a diagram illustrating an example of source codes of a matrix operation;

FIG. 4 is a diagram illustrating an example of functions of the information processing apparatus;

FIG. 5 is a diagram illustrating an example of data processed by the information processing apparatus;

FIG. 6 is a flowchart illustrating an example of processing of the information processing apparatus;

FIG. 7 is a diagram illustrating an example of a matrix-vector multiplication program;

FIG. 8 is a diagram illustrating an example of a sparse matrix-vector multiplication program;

FIG. 9 is a diagram illustrating an example of algorithm SCoP information;

FIG. 10 is a diagram illustrating a first example of optimized SCoP information;

FIG. 11 is a diagram illustrating a second example of the optimized SCoP information;

FIG. 12 is a diagram illustrating a third example of the optimized SCoP information;

FIG. 13 is a flowchart illustrating an example of a use possibility determination;

FIG. 14 is a diagram illustrating an example of sparse matrix information (CSR);

FIG. 15 is a diagram illustrating an example of sparse matrix information (CSC);

FIG. 16 is a diagram illustrating an example of sparse matrix information (COO);

FIG. 17 is a flowchart illustrating an example of generation of an optimized program code candidate set;

FIG. 18 is a diagram illustrating an example of right side expression information;

FIG. 19 is a diagram illustrating an example of data type information;

FIG. 20 is a diagram illustrating a first example of an optimized program code candidate;

FIG. 21 is a diagram illustrating a second example of the optimized program code candidate;

FIG. 22 is a diagram illustrating a third example of the optimized program code candidate;

FIG. 23 is a diagram illustrating a fourth example of the optimized program code candidate;

FIG. 24 is a diagram illustrating an example of sparse matrix specialization information;

FIG. 25 is a diagram illustrating a sixth example of the optimized program code candidate;

FIG. 26 is a diagram illustrating a seventh example of the optimized program code candidate; and

FIG. 27 is a diagram illustrating an example of optimization strategy instruction information.

### DESCRIPTION OF EMBODIMENTS

There is a matrix operation as loop processing that may access a large amount of data. In the matrix operation, a sparse matrix sometimes becomes a processing target. The sparse matrix is a data structure used in a case where a matrix or vector has many zero elements. The sparse matrix does not explicitly hold zeros but holds data of non-zeros and information indicating at which positions the non-zeros are present. The use of the sparse matrix reduces an amount of data transferred between a memory and the CPU and enables the effective use of the cache, and thus may speed up execution of the program.

To make execution of the program more efficient, optimization with a compiler or optimization at a source code level is sometimes performed in a process of converting a source code into an executable code.

For example, there is a proposal regarding a compilation processing apparatus that permits execution of an unnecessary operation related to a sparse matrix to be omitted by inserting an instruction statement that permits omission of execution of the unnecessary operation into a source program.

There has been proposed a technique for extracting hotspots for which parallel operations may be performed from a source code of an application program and automatically generating a code for an accelerator device. A proposed calculator extracts, by using a convex polyhedral model, a loop structure called static control parts (SCoP) from an intermediate code generated from a source code. The calculator divides the detected loop structure into a CPU processing part and a graphics processing unit (GPU) processing part, and places checkpoint processing in the intermediate code in the CPU processing part. The calculator generates a CPU machine code or a GPU assembly code from each function of the intermediate code.

There is also a proposal regarding a computer system that creates a directed acyclic graph from computer system instructions, determines a convex polyhedral representation of the directed acyclic graph, and determines, by using the convex polyhedral representation, optimization to be applied to an execution schedule of the computer system instructions. Based on this execution schedule and processor architecture, the proposed computer system generates an executable code of the computer system instructions.

There is also a proposal regarding a compiler technique for using convex polyhedral loop conversion to optimize a source code during compilation.

There is also a proposal regarding a method of optimizing a program in a SCoP format by using a convex polyhedral model. An apparatus that executes the proposed method may apply various kinds of loop optimization using a convex polyhedral model to a code in the SCoP format that serves as a base, and generate a plurality of optimized codes in the SCoP format.

Because a source code of sparse matrix processing includes use of a pointer and an indirect reference to data, it is difficult to perform optimization with a compiler. Accordingly, an optimized library is prepared in advance for various algorithms of the sparse matrix processing that may be written in a source code, and this library is sometimes utilized.

However, in the sparse matrix processing, parameters such as various sparse matrix formats, data types, and properties of the sparse matrix according to a distribution of non-zeros greatly affect the performance of these algorithms of the sparse matrix processing. Thus, the performance achieved with the library prepared in advance may become insufficient. For example, to utilize the properties of the sparse matrix, a just-in-time compilation method may be used in which an optimized code is created, compiled, and executed at run time. However, the library prepared in advance is unable to cope with the just-in-time compilation method. In a case where the library prepared in advance does not conform to a data structure or an algorithm of the sparse matrix processing used by a program writer, this library is not applicable.

In one aspect, an object of the present disclosure is to provide a computer-readable recording medium storing a program and an information processing method capable of efficiently obtaining an optimized source code for sparse matrix processing.

The present embodiments will be described below with reference to the drawings.

### First Embodiment

A first embodiment will be described.

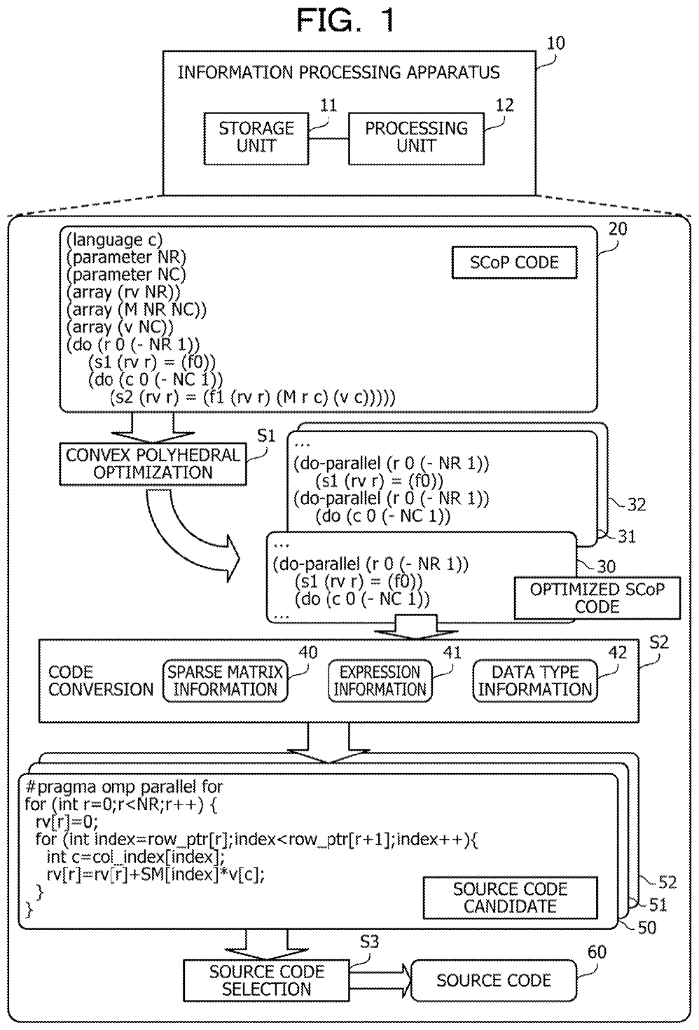

FIG. 1 is a diagram illustrating an information processing apparatus according to the first embodiment.

An information processing apparatus 10 assists generation of a source code for sparse matrix processing. The information processing apparatus 10 includes a storage unit 11 and a processing unit 12. The storage unit 11 may be a volatile storage device such as a random-access memory (RAM) or may be a nonvolatile storage device such as a hard disk drive (HDD) or a flash memory. The processing unit 12 may include a CPU, a digital signal processor (DSP), an application-specific integrated circuit (ASIC), a field-programmable gate array (FPGA), or the like. The processing unit 12 may be a processor that executes a program. The “processor” may include a set of a plurality of processors (multiprocessor).

First, the processing unit 12 acquires a SCoP code 20 input to the information processing apparatus 10. The SCoP code 20 is a code in which loop processing on a matrix is written in a static control part format, for example, a SCoP format. The SCoP code 20 is a representation in which an algorithm of a certain matrix-vector multiplication is abstracted. SCoP is a loop description in which all the array indices and loop conditional statements are represented by affine expressions. An affine expression is an expression that is an addition of a linear combination of loop variables and a constant term. However, in the SCoP code 20, data type information and a specific calculation method of the right side of an assignment statement, which are usually present in a source code, are abstracted and omitted. For example, the right side of the assignment statement is abstracted only to a description “f0” or “f1” that represents a function. A description “do” in the SCoP code 20 represents a loop.

The SCoP code 20 is created in advance in accordance with sparse matrix processing desired by a user. As an example, the SCoP code 20 indicates an operation of a matrix-vector multiplication “y=A*x” for a matrix A and column vectors x and y. In the SCoP code 20, the matrix A is represented as a two-dimensional array M. The column vector x is represented by a one-dimensional array v. The column vector y is represented by a one-dimensional array rv. The number of rows and the number of columns of the matrix A are NR and NC, respectively. An index indicating a row of the matrix A and an index indicating a column of the matrix A are r and c, respectively. For example, a description “do (r0(−NR1))” indicates that a loop is executed while the index r is incremented by 1 from 0 to NR−1. The SCoP code 20 may be referred to as a first code.

By optimizing the SCoP code 20 with a convex polyhedral model, the processing unit 12 acquires a plurality of optimized SCoP codes (step S1). Optimization with a convex polyhedral model is referred to as convex polyhedral optimization. Each of the plurality of optimized SCoP codes is an optimized SCoP code of the SCoP code 20. As tools for performing the convex polyhedral optimization on the SCoP code, there are Polly, PLUTE, Graphite, and the like, for example.

The processing unit 12 analyzes and models loop structures included in the SCoP code 20 in a manner of linear algebra by using the convex polyhedral model, and calculates a data dependency relationship and a boundary condition. In this manner, the processing unit 12 extracts parallelism and applies loop optimization such as loop fission and loop interexchange. The processing unit 12 generates a plurality of patterns of optimized SCoP codes for the SCoP code 20 through the convex polyhedral optimization. For example, the plurality of optimized SCoP codes include optimized SCoP codes 30, 31, and 32. Each of the optimized SCoP codes 30, 31, and 32 may be referred to as a second code.

For example, the processing unit 12 generates the optimized SCoP code 30 in which outer loops in the SCoP code 20 are parallelized. In this case, the processing unit 12 generates the optimized SCoP code 30 by replacing a portion “do(r0(−NR 1))” of the SCoP code 20 with “do-parallel(r0(−NR1))”, for example. A description “do-parallel” represents parallelization of loops.

For example, by applying loop fission optimization for separating a statement s1 of the SCoP code 20 in a different loop, the processing unit 12 generates the optimized SCoP code 31 in which loops are parallelized in the respective outer loops. In this case, the processing unit 12 replaces the portion “do(r0(−NR 1))” of the SCoP code 20 with “do-parallel(r0(−NR1))”. By inserting “do-parallel(r0(−NR1))” at a row immediately before “do (c0(−NR 1))”, the processing unit 12 generates the optimized SCoP code 31.

The processing unit 12 may generate the optimized SCoP code 32 obtained by applying another loop optimization such as optimization using both loop fission and loop interexchange to the SCoP code 20, for example. In this manner, the processing unit 12 generates the plurality of patterns of the optimized SCoP codes 30, 31, and 32.

Based on sparse matrix information 40, expression information 41, and data type information 42, the processing unit 12 converts the plurality of optimized SCoP codes into a plurality of source code candidates (step S2). The sparse matrix information 40 is information that indicates a variable that represents a non-zero element of a sparse matrix that is a processing target. This variable is a variable used in a target source code. As a variable name of this variable, the processing unit 12 may use the same variable name as the variable name written in each optimized SCoP code. As described later, the processing unit 12 may add a variable not included in each optimized SCoP code, based on the sparse matrix information 40.

The expression information 41 is information that indicates an operation expression that corresponds to a function included in the optimized SCoP code. For example, the expression information 41 indicates expressions related to the functions f0 and f1 of the right side of the assignment statements included in each of the optimized SCoP codes 30, 31, and 32. In this example, the expression information 41 includes information associating the function f0 with 0. The expression information 41 includes information associating the function f1 with an expression for adding the product of a second argument and a third argument to a first argument of the function f1. The first argument, the second argument, and the third argument of the function f1 in the SCoP code 20 and in the optimized SCoP codes 30, 31, and 32 are rv, M, and v, respectively. In the conversion in step S2, the processing unit 12 converts the two-dimensional array M into a one-dimensional array (for example, an array SM) that corresponds to the sparse matrix. The data type information 42 is information that indicates a type that corresponds to the variable in the target source code, such as an array or an index included in the optimized SCoP code. The sparse matrix information 40, the expression information 41, and the data type information 42 are created in advance in accordance with the sparse matrix processing desired by the user and are stored in the storage unit 11.

The optimized SCoP codes 30, 31, and 32 generated in step S1 are written in the SCoP format and are not descriptions corresponding to the sparse matrix processing in a programming language used by the user. Accordingly, based on the sparse matrix information 40, the expression information 41, and the data type information 42, the processing unit 12 converts the optimized SCoP codes into descriptions in this programming language. In this manner, the processing unit 12 obtains source code candidates in which the representation of the sparse matrix to be used is reflected. In this example, C is exemplified as the programming language. Information on the programming language to be used is included in the SCoP code 20. For example, a description “(language c)” in the SCoP code 20 corresponds to the information on the programming language. Thus, the optimized SCoP codes 30, 31, and 32 also include this information on the programming language.

A data structure that explicitly holds zero values together with non-zero values is referred to as a dense matrix. The array M described above may be said to have a data structure of the dense matrix. A sparse matrix has a data structure obtained by deleting zero elements from the dense matrix. The sparse matrix is to have additional information that indicates at which positions in the original dense matrix the non-zero elements are present. There are various sparse matrix representation methods based on the additional information. A difference between these representation methods is a difference between formats of the sparse matrix. Description content of the source code greatly changes depending on the format to be used.

Examples of the format of the sparse matrix representation for a two-dimensional matrix include a compressed sparse row (CSR) format, a compressed sparse column (CSC) format, a coordinate (COO) format, and the like. The CSR format is a format in which non-zero elements are compressed in a row direction and held and column information of each element is held. The CSC format is a format in which non-zero elements are compressed in a column direction and held and row information of each element is held. The COO format is a format in which row information and column information are held for non-zero elements. The sparse matrix information 40 indicates variables to be used in association with any of the formats that represent non-zero elements of such a sparse matrix and a dependency relationship between the variables. The sparse matrix information 40 is created in advance in accordance with the format to be used.

For example, through the conversion in step S2, the processing unit 12 obtains a source code candidate 50 obtained by applying the sparse matrix information 40 for the CSR format to the optimized SCoP code 30. In the source code candidate 50, the two-dimensional array M used for the matrix A is converted into the one-dimensional array SM. In the case of the CSR format, in the sparse matrix information 40, a variable r for a row number, a start “0” and an end “NR” of a loop that may be designated for the variable r, and a variable (for example, index) that indicates a position of a non-zero element included in the row of the row number r in the array SM are set. In the sparse matrix information 40, a variable c into which a value of an array (for example, col_index[index]) that holds a column number of the non-zero element is to be substituted is set. In the sparse matrix information 40, the start value and the end value of the loop of the above index represented by an array (for example, row_ptr[r]) that holds a head position in the row r in the array SM are set. The row r indicates the row with the row number r. Types used for the variables r, c, and index and the arrays rv, SM, v, row_ptr, and col_index, and the like included in the source code candidate 50 are registered in the data type information 42 in advance. An illustration of a portion defining the arrays is omitted in the source code candidate 50.

Based on the description “do-parallel(r0(−NR1))” in the optimized SCoP code 30, the processing unit 12 inserts a parallelization instruction statement at a position corresponding to this description portion. The source code candidate 50 indicates an example in which an Open Multi-Processing (OpenMP, registered trademark) directive “#pragma omp parallel for” is inserted.

Likewise, through the conversion in step S2, the processing unit 12 obtains a source code candidate 51 for the optimized SCoP code 31. Through the conversion in step S2, the processing unit 12 obtains a source code candidate 52 for the optimized SCoP code 32.

The processing unit 12 evaluates the processing performance for on the sparse matrix in a case where each of the plurality of source code candidates is used. In accordance with this performance evaluation, the processing unit 12 selects a source code 60 from among the plurality of source code candidates (step S3). The source code 60 is an optimized source code to be finally output by the information processing apparatus 10. The number of source codes 60 to be selected may be one or may be plural.

For example, the processing unit 12 generates an executable code by compiling each of the source code candidates, processes the sparse matrix with the executable code, and measures a processing time. In this manner, the processing unit 12 evaluates the performance. In this case, the processing unit 12 preferentially selects the source code candidate corresponding to the executable code of which the processing time is short.

Alternatively, the processing unit 12 may perform performance evaluation for each source code candidate and the actual sparse matrix by using a machine learning model that outputs an indicator of a performance evaluation result such as a processing time, for features of the source code candidate and the sparse matrix. In this case, the processing unit 12 preferentially selects the source code candidate corresponding to the executable code of which the indicator of the performance evaluation result is good.

According to the information processing apparatus 10, a plurality of second codes are acquired by optimizing, with a convex polyhedral model, a first code in which loop processing on a matrix is written in a static control part format. The plurality of second codes are converted into a plurality of source code candidates, based on sparse matrix information that indicates a variable that represents a non-zero element of the sparse matrix, expression information that indicates an operation expression that corresponds to a function included in the second codes, and data type information that indicates a type used for the variable. A source code is selected from among the plurality of source code candidates in accordance with evaluation of processing performance for the sparse matrix in a case where each of the plurality of source code candidates is used.

Thus, the information processing apparatus 10 may efficiently obtain an optimized source code for sparse matrix processing.

Because the source code of the sparse matrix processing includes use of a pointer and an indirect reference to data, it is difficult to perform optimization with a compiler. Accordingly, an optimized library is prepared in advance for various algorithms of the sparse matrix processing that may be written in a source code, and this library is sometimes utilized. However, the library prepared in advance is unable to cope with the just-in-time compilation method. In a case where the library prepared in advance does not conform to a data structure or an algorithm of the sparse matrix processing used by a program writer, optimization with the library is not applicable. Updating the library prepared in advance accordingly in such a case is conceivable. However, updating the library takes time and effort.

Accordingly, the information processing apparatus 10 automatically generates the optimized source code 60 for the sparse matrix processing. For example, the information processing apparatus 10 obtains a plurality of optimized SCoP codes by optimizing the SCoP code 20 in which an algorithm of the sparse matrix processing is written, instead of directly converting the source code into an optimized code. This allows the information processing apparatus 10 to use loop optimization using a convex polyhedral model that is not applicable to the source code in which the sparse matrix processing is written. By utilizing an existing tool for performing convex polyhedral optimization, the information processing apparatus 10 may easily use loop optimization using a convex polyhedral model.

The information processing apparatus 10 converts the plurality of optimized SCoP codes into a plurality of source code candidates written in a predetermined programming language, based on the sparse matrix information 40, the expression information 41, and the data type information 42 that are in accordance with a sparse matrix format, a data type, and properties of the sparse matrix. The information processing apparatus 10 selects any of the source code candidates as the source code 60 in accordance with evaluation of processing performance for the actual sparse matrix in a case where each of the source code candidates is used.

Thus, the information processing apparatus 10 may efficiently obtain the optimum source code 60 suitable for a user environment. For example, even in a case where the data type used in the sparse matrix or the format of the right side of the assignment statement is changed in the SCoP code 20 as a result of omitting the data type and specific information of the right side expression, the information processing apparatus 10 may easily obtain an effect of loop optimization using a convex polyhedral model. By executing the executable code obtained as a result of compiling the optimized source code 60 and by performing the sparse matrix processing, the information processing apparatus 10 may reduce an amount of data transferred between a CPU and a memory such as a RAM and may speed up the sparse matrix processing.

Functions of the information processing apparatus 10 will be described in detail below by using a more specific example.

### Second Embodiment

Next, a second embodiment will be described.

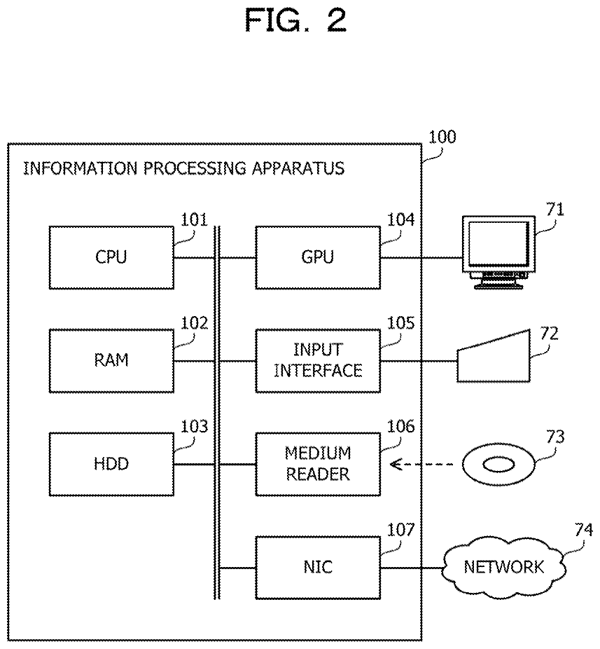

FIG. 2 is a diagram illustrating an example of hardware of an information processing apparatus according to the second embodiment.

An information processing apparatus 100 generates an optimum source code for sparse matrix processing. As an example, it is assumed that a programming language is C. However, the programming language may be another programming language other than C.

The information processing apparatus 100 includes a CPU 101, a RAM 102, an HDD 103, a GPU 104, an input interface 105, a medium reader 106, and a network interface card (NIC) 107. The CPU 101 is an example of the processing unit 12 according to the first embodiment. The RAM 102 or the HDD 103 is an example of the storage unit 11 according to the first embodiment.

The CPU 101 is a processor that executes instructions of a program. The CPU 101 loads at least part of the program and data stored in the HDD 103 into the RAM 102 and executes the program. The CPU 101 may include a plurality of processor cores. The information processing apparatus 100 may include a plurality of processors. Processing described below may be executed in parallel by using the plurality of processors or processor cores. A set of the plurality of processors is sometimes referred to as a “multiprocessor” or merely a “processor”.

The RAM 102 is a volatile semiconductor memory that temporarily stores the program executed by the CPU 101 and data used in an operation performed by the CPU 101. The information processing apparatus 100 may include a memory of a type other than the RAM and may include a plurality of memories.

The HDD 103 is a nonvolatile storage device that stores data and programs of software such as an operating system (OS), middleware, and application software. The information processing apparatus 100 may include a storage device of another type such as a flash memory or a solid-state drive (SSD) or may include a plurality of nonvolatile storage devices.

In accordance with an instruction from the CPU 101, the GPU 104 outputs an image to a display 71 coupled to the information processing apparatus 100. As the display 71, an arbitrary type of a display such as a cathode ray tube (CRT) display, a liquid crystal display (LCD), a plasma display, or an organic electro-luminescence (OEL) display may be used.

The input interface 105 obtains an input signal from an input device 72 coupled to the information processing apparatus 100 and outputs the input signal to the CPU 101. As the input device 72, a pointing device such as a mouse, a touch panel, a touchpad, or a trackball, a keyboard, a remote controller, a button switch, or the like may be used. A plurality of kinds of input devices may be coupled to the information processing apparatus 100.

The medium reader 106 is a reading device that reads a program and data recorded on a recording medium 73. As the recording medium 73, for example, a magnetic disk, an optical disc, a magneto-optical (MO) disk, a semiconductor memory, or the like may be used. Examples of the magnetic disk include a flexible disk (FD) and an HDD. Examples of the optical disc include a compact disc (CD) and a Digital Versatile Disc (DVD).

For example, the medium reader 106 copies the program and the data read from the recording medium 73 to another recording medium such as the RAM 102 or the HDD 103. The read program is executed by, for example, the CPU 101. The recording medium 73 may be a portable recording medium and used to distribute the program and the data. The recording medium 73 or the HDD 103 is sometimes referred to as a computer-readable recording medium.

The NIC 107 is an interface that is coupled to a network 74 and that communicates with another computer via the network 74. The NIC 107 is coupled to, for example, a communication device such as a switch or a router through a cable. The NIC 107 may be an interface that performs wireless communication.

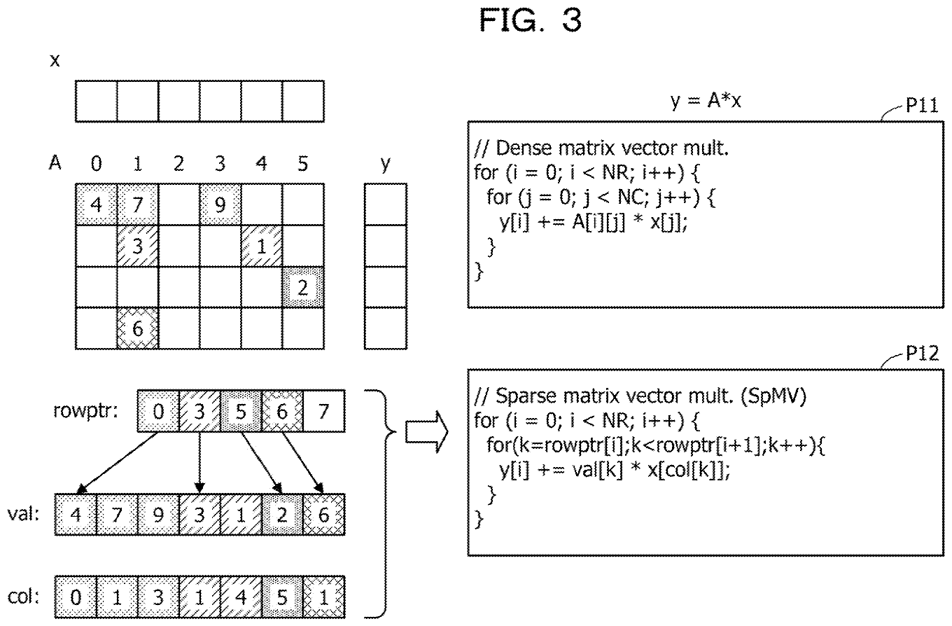

FIG. 3 is a diagram illustrating an example of source codes of a matrix operation.

Source codes P11 and P12 indicate examples of descriptions of a matrix-vector multiplication “y=A*x”. A denotes a matrix having NR rows and NC columns. Each of NR and NC is an integer of two or greater. x denotes a column vector of the NC rows. y denotes a column vector of the NR rows. In the example in FIG. 3, NR=4 and NC=6. The source code P11 is an example of a description for a dense matrix. The source code P12 is an example of a description for a sparse matrix. The source code P12 is a source code corresponding to the CSR format. A vector multiplication for a sparse matrix is referred to as a sparse matrix-vector multiplication (SpMV).

The matrix A includes a relatively large number of zeros. In FIG. 3, blank portions in the matrix A indicate zero elements of the matrix A. Portions, of the matrix A, where non-zero values are written indicate non-zero elements of the matrix A. In the example of the CSR format, the non-zero elements of the matrix A are compressed in a row direction, for example, are held in a one-dimensional array (for example, val) by omitting zeros. Because the number of non-zero elements of the matrix A is 7, the number of elements in the array val is 7. An index, of the array val, corresponding to the first element in each row of the matrix A is held in a one-dimensional array (for example, rowptr). An index of the array rowptr is a row number i in the matrix A. For each element held in the array val, a column number of this element in the matrix A is held in a one-dimensional array (for example, col). An index for the array col is the same as the index of the array val. The array rowptr holds the total number of non-zero elements as the last element. This is for recognizing the end position of the last row when rowptr[i+1] exceeds the last row number.

In the source code P12, the use of the data structure of the sparse matrix enables an amount of data held in the array to be reduced as compared with an amount of data when the dense matrix is used in the source code P11, which may consequently reduce an amount of data transferred between the RAM 102 and the CPU 101. However, because the source code of the sparse matrix processing includes use of a pointer and an indirect reference to data, it is difficult to perform optimization with a compiler. For example, if the number of elements to be processed in each loop varies due to a distribution of zeros and non-zero values in the sparse matrix, the optimization with the compiler may not sufficiently improve the processing performance. Accordingly, the information processing apparatus 100 provides a function of automatically generating an optimized source code for the sparse matrix processing.

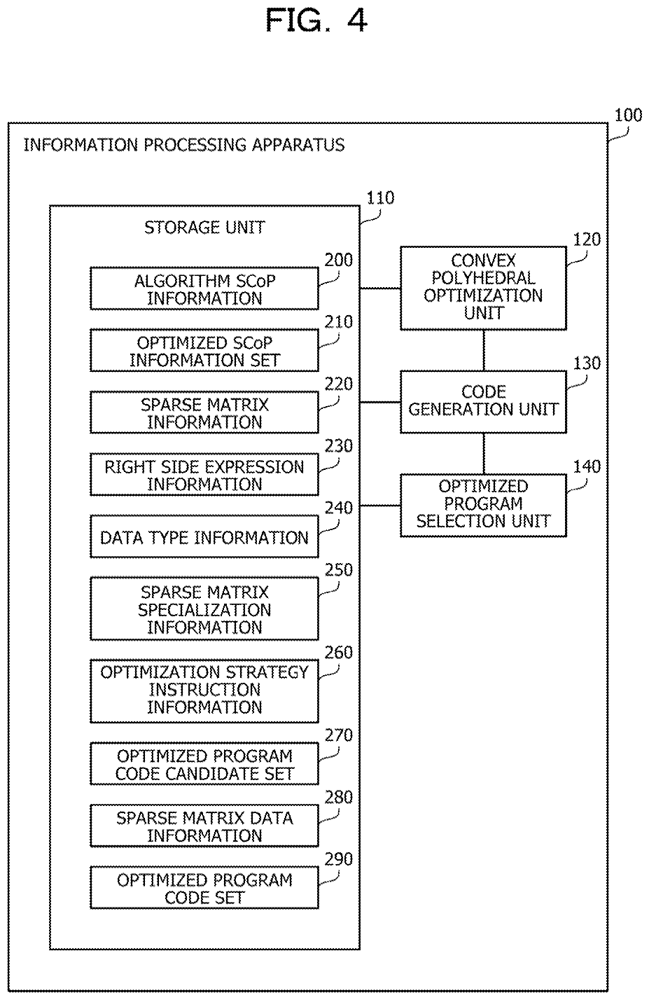

FIG. 4 is a diagram illustrating an example of functions of the information processing apparatus.

The information processing apparatus 100 includes a storage unit 110, a convex polyhedral optimization unit 120, a code generation unit 130, and an optimized program selection unit 140. A storage area of the RAM 102 or the

HDD 103 is used as the storage unit 110. By executing a program stored in the RAM 102, the CPU 101 exhibits functions of the convex polyhedral optimization unit 120, the code generation unit 130, and the optimized program selection unit 140.

The storage unit 110 stores various kinds of data to be used in processing of the convex polyhedral optimization unit 120, the code generation unit 130, and the optimized program selection unit 140. The storage unit 110 includes algorithm SCoP information 200, an optimized SCoP information set 210, sparse matrix information 220, right side expression information 230, data type information 240, sparse matrix specialization information 250, optimization strategy instruction information 260, an optimized program code candidate set 270, sparse matrix data information 280, and an optimized program code set 290.

The algorithm SCoP information 200 is information in which an algorithm of a matrix-vector multiplication is written in the SCoP format. In the algorithm SCoP information 200, the algorithm of the matrix-vector multiplication is written as loop processing on a dense matrix. In the algorithm SCoP information 200, data type information is omitted and a specific calculation method of the right side of an assignment statement is abstracted and omitted by writing only a function name. The algorithm SCoP information 200 is an example of the SCoP code 20 according to the first embodiment, for example, a first code.

The optimized SCoP information set 210 is a set of optimized SCoP information that is an optimized result of the algorithm SCoP information 200 obtained by the convex polyhedral optimization unit 120. The optimized SCoP information is an example of the optimized SCoP code 30, 31, or 32 according to the first embodiment, for example, a second code.

The sparse matrix information 220 indicates a variable that represents non-zero elements of the sparse matrix. For example, the sparse matrix information 220 is information that indicates a plurality of variables used in representation of the non-zero elements of the matrix A and a dependency relationship between the variables, in accordance with the format of the sparse matrix.

The right side expression information 230 is information for converting a right side expression of the assignment statement omitted in the optimized SCoP information into a description in a target source code. The right side expression information 230 is an example of the expression information 41 according to the first embodiment.

The data type information 240 is information that indicates a type of the variable in the target source code. As a variable name in the target source code, a variable name included in the optimized SCoP information is used. However, the array of the dense matrix in the optimized SCoP information is replaced with an array of the sparse matrix.

The sparse matrix specialization information 250 is information for specializing the type of the variable in accordance with a range of the values (possible values) of the non-zero elements included in the sparse matrix, the number of non-zero elements, or the like. For example, data specialization may be performed such that, in a case where the non-zero elements have only a specific value, the elements of the sparse matrix are represented only by this specific value or in a case where the number of non-zero elements is relatively small, the type of the index of the array is changed to a type with a smaller size.

The optimization strategy instruction information 260 is information for instructing the code generation unit 130 of a to-be-used optimization method such as parallelization or data specialization.

The optimized program code candidate set 270 is a set of optimized program code candidates obtained as a result of each element of the optimized SCoP information set 210, for example, the optimized SCoP information being converted by the code generation unit 130. The optimized program code candidates are an example of the source code candidates 50, 51, and 52 according to the first embodiment.

The sparse matrix data information 280 is information that indicates a sparse matrix actually used.

The optimized program code set 290 is a set of optimized program codes selected from among the optimized program code candidate set 270 by the optimized program selection unit 140. The optimized program code is an example of the source code 60 according to the first embodiment.

The convex polyhedral optimization unit 120 generates the optimized SCoP information set 210 by applying various kinds of loop optimization to the algorithm SCoP information 200 by using a convex polyhedral model. The convex polyhedral optimization unit 120 may generate the optimized SCoP information set 210 by using Polly, PLUTE, Graphite, or the like, which is a tool for performing optimization using a convex polyhedral model.

The code generation unit 130 generates the optimized program code candidate set 270 by converting each element of the optimized SCoP information set 210 into an optimized program code candidate, based on the sparse matrix information 220, the right side expression information 230, and the data type information 240. The optimized program code candidate is a candidate for a source code written in the target programming language. In this example, as described above, this programming language is C. Based on the sparse matrix specialization information 250 or the optimization strategy instruction information 260, the code generation unit 130 may convert each element of the optimized SCoP information set 210 into the optimized program code candidate.

The optimized program selection unit 140 evaluates the processing performance for the sparse matrix data information 280 in a case where each element of the optimized program code candidate set 270, for example, the optimized program code candidate is used. The optimized program selection unit 140 selects the optimized program code set 290 from among the optimized program code candidate set 270 in accordance with this evaluation of the processing performance.

For example, the optimized program selection unit 140 generates an executable code by compiling each optimized program code candidate, processes the sparse matrix data information 280 with the executable code, and measures a processing time. In this manner, the optimized program selection unit 140 evaluates the processing performance. In this case, for example, the optimized program selection unit 140 preferentially selects a predetermined number of optimized program code candidates that correspond to executable codes of which the processing times are short.

Alternatively, the optimized program selection unit 140 may perform performance evaluation for the actual sparse matrix and each optimized program code candidate by using a machine learning model. As the machine learning model, the optimized program selection unit 140 uses a model that outputs an indicator of a performance evaluation result such as a processing time, for features of the optimized program code candidate and the sparse matrix data information 280. In this case, for example, the optimized program selection unit 140 preferentially selects a predetermined number of optimized program code candidates that correspond to the executable codes of which the indicators of the performance evaluation results are good.

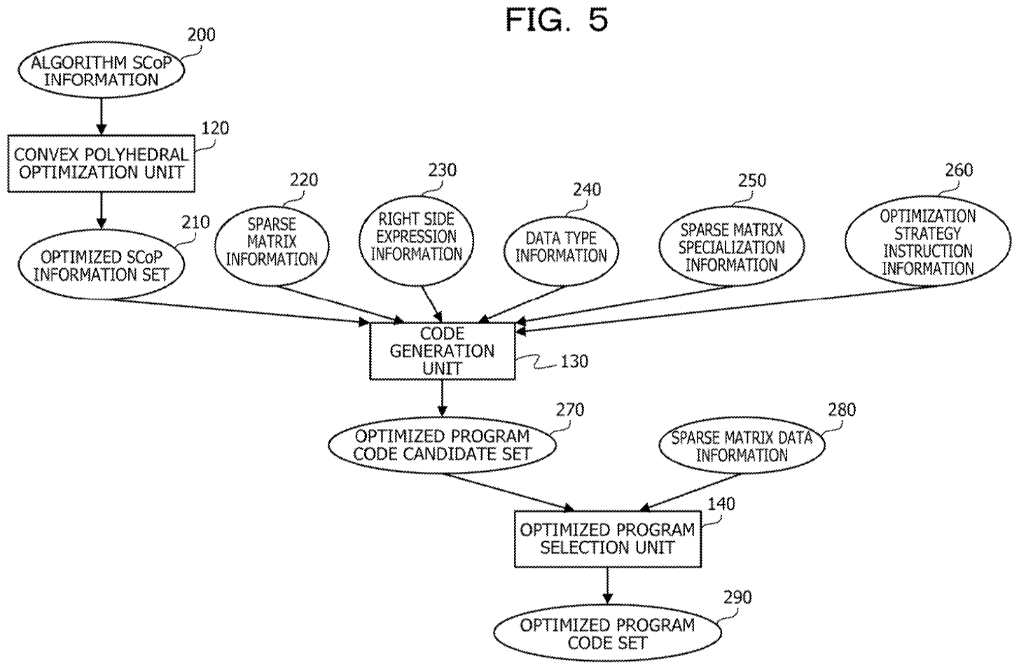

FIG. 5 is a diagram illustrating an example of data processed by the information processing apparatus.

As described above, the algorithm SCoP information 200 is an input to the convex polyhedral optimization unit 120. The optimized SCoP information set 210 is an output from the convex polyhedral optimization unit 120.

The optimized SCoP information set 210, the sparse matrix information 220, the right side expression information 230, the data type information 240, the sparse matrix specialization information 250, and the optimization strategy instruction information 260 are inputs to the code generation unit 130. The optimized program code candidate set 270 is an output from the code generation unit 130.

The optimized program code candidate set 270 and the sparse matrix data information 280 are inputs to the optimized program selection unit 140. The optimized program code set 290 is an output from the optimized program selection unit 140.

The algorithm SCoP information 200 is created in advance in accordance with sparse matrix processing desired by a user, and is input to the information processing apparatus 100. The sparse matrix information 220, the right side expression information 230, the data type information 240, the sparse matrix specialization information 250, the optimization strategy instruction information 260, and the sparse matrix data information 280 are stored in the storage unit 110 in advance.

Next, a procedure of processing of the information processing apparatus 100 will be described.

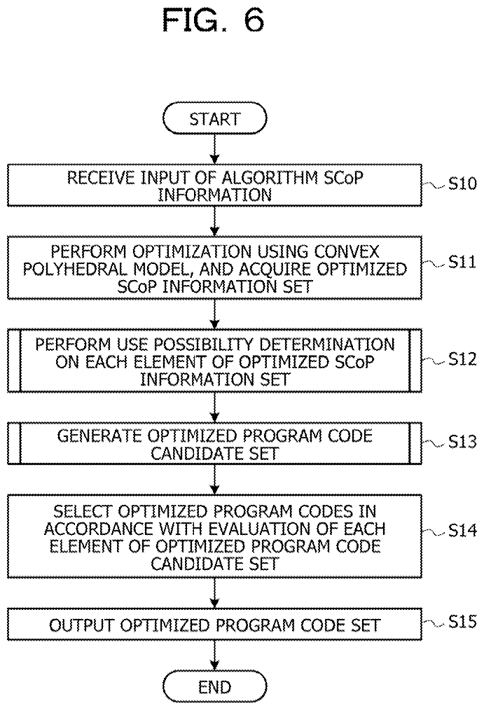

FIG. 6 is a flowchart illustrating an example of processing of the information processing apparatus.

(S10) The convex polyhedral optimization unit 120 receives an input of the algorithm SCoP information 200.

(S11) The convex polyhedral optimization unit 120 performs convex polyhedral optimization on the algorithm SCoP information 200, and acquires the optimized SCoP information set 210 as a result of the convex polyhedral optimization.

(S12) The code generation unit 130 performs a use possibility determination on each element of the optimized SCoP information set. By performing the use possibility determination, the code generation unit 130 excludes in advance an element that is apparently not usable for the sparse matrix information 220 from the optimized SCoP information set 210. For example, if each element X of the optimized SCoP information set 210 does not conform to the sparse matrix information 220, the code generation unit 130 discards the element X as being not usable. If the element X is usable, the code generation unit 130 adds the element X to a set SET. Details of the use possibility determination will be described later.

(S13) The code generation unit 130 generates an optimized program code candidate set. The code generation unit 130 generates the optimized program code candidate set 270 by converting each element Y of the set SET into an optimized program code candidate, based on the sparse matrix information 220, the right side expression information 230, and the data type information 240. Details of generation of the optimized program code candidate set will be described later.

(S14) The optimized program selection unit 140 evaluates the processing performance for the sparse matrix data information 280 in a case where each element Z of the optimized program code candidate set 270 is used. The optimized program selection unit 140 selects the optimized program code set 290 from among the optimized program code candidate set 270 in accordance with this evaluation of the processing performance.

For example, the optimized program selection unit 140 may acquire the optimized program code set 290 by actually compiling and executing each element Z by using the sparse matrix data information 280, and by leaving elements of which the execution time is shorter than a threshold and discarding the rest.

The optimized program selection unit 140 may predict the performance of each element Z by using a machine learning model that utilizes the features of the description content of the corresponding element Z and the sparse matrix data information 280. In this case, the optimized program selection unit 140 may acquire the optimized program code set 290 by leaving highly probable elements and discarding the rest, based on indicators indicating the performance evaluation results output for the respective elements by the machine learning model.

(S15) The optimized program selection unit 140 outputs the optimized program code set 290. For example, the optimized program selection unit 140 may cause the display 71 to display the optimized program code set 290. The optimized program selection unit 140 may transmit the optimized program code set 290 to another computer via the network 74.

Next, a specific input/output example in steps S10 and S11 will be described. First, the algorithm SCoP information 200 will be described. The algorithm SCoP information 200 is created in advance in accordance with an algorithm of a matrix-vector multiplication program for a dense matrix. As an example, a matrix-vector multiplication “y=A*x” is presented.

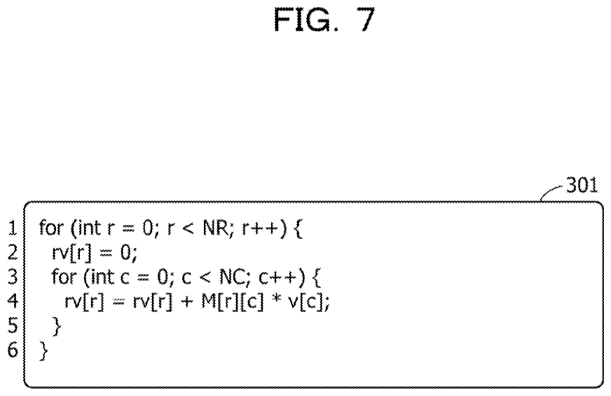

FIG. 7 is a diagram illustrating an example of a matrix-vector multiplication program.

A matrix-vector multiplication program 301 is an example of a description of a matrix-vector multiplication for a dense matrix. For example, the elements of the matrix A are held in the two-dimensional array M. An element of the column vector x is held in the array v. An element of the column vector y is held in the array rv. The description of the matrix-vector multiplication program 301 is relatively short. However, this portion may occupy a large part (for example, 80% or more) of the execution time in an actual HPC application.

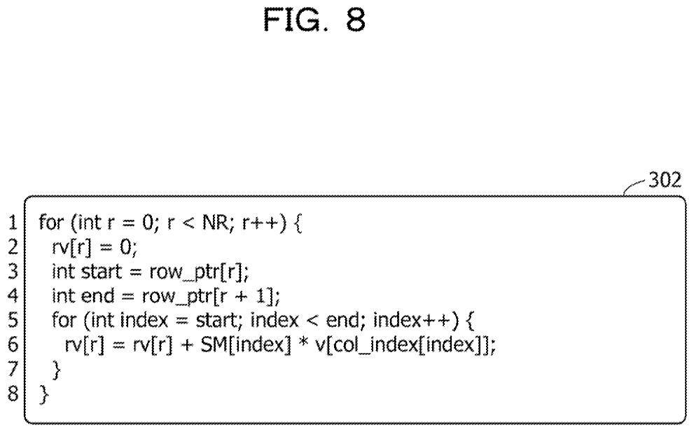

FIG. 8 is a diagram illustrating an example of a sparse matrix-vector multiplication program.

A sparse matrix-vector multiplication program 302 is an example of a description of a sparse matrix-vector multiplication for a sparse matrix in the CSR format. For example, non-zero values of the sparse matrix are held in the one-dimensional array SM. The index of this array SM and the index of the array v are indirectly represented by the array row_ptr and the array col_index, respectively.

For example, when causing the information processing apparatus 100 to automatically generate a source code, the user does not have to write the sparse matrix-vector multiplication program 302 in advance. Instead, the user may input information on the variables r, c, and index used in the CSR format and the types of the arrays r, rv, SM, and the like to the information processing apparatus 100 as the sparse matrix information 220 and the data type information 240.

The user creates the algorithm SCoP information 200 in which the algorithm of the matrix-vector multiplication program 301 is abstracted, and inputs the algorithm SCoP information 200 to the information processing apparatus 100.

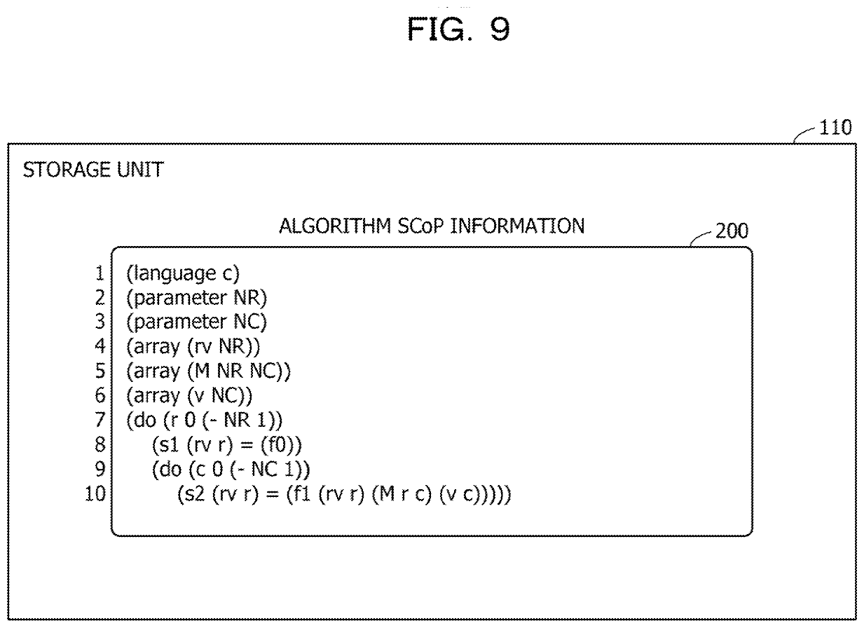

FIG. 9 is a diagram illustrating an example of the algorithm SCoP information.

In the algorithm SCoP information 200, the data type information and the specific calculation method of the right side of the assignment statement in the matrix-vector multiplication program 301 is abstracted and omitted. For example, only function names such as “f0” and “f1” and arguments of the functions are written at portions where the calculation methods are omitted.

For example, line 1 of the algorithm SCoP information 200 is a statement specifying a programming language (C in this example) to be used. Lines 2 and 3 of the algorithm SCoP information 200 are definitions of the variables NR and NC that respectively indicate the row number and the column number in the matrix A. Lines 4 to 6 of the algorithm SCoP information 200 are definitions of the arrays rv, M, and v and the indices of these arrays. “array” indicates an array. For example, a description “array (rv NR)” is a definition of the one-dimensional array rv of which the number of elements is NR. A description “array (M NR NC)” is a definition of the two-dimensional array M of which the number of elements is NR*NC. Lines 7 to 10 of the algorithm SCoP information 200 are a description of an abstracted algorithm. “do” indicates a loop. “s1” and “s2” are identifiers of the respective assignment statements.

By performing convex polyhedral optimization on the algorithm SCoP information 200, the convex polyhedral optimization unit 120 generates, for example, a plurality of patterns of optimized SCoP information below.

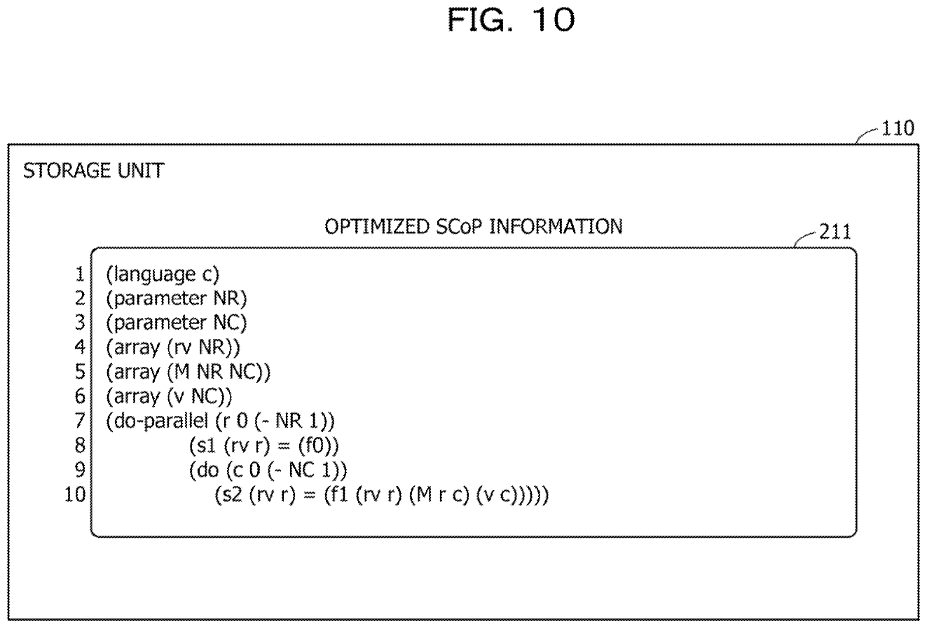

FIG. 10 is a diagram illustrating a first example of the optimized SCoP information.

As compared with the algorithm SCoP information 200, the input data and the loop format are not changed in optimized SCoP information 211. However, the optimized SCoP information 211 is a result obtained when outer loops are determined to be parallelizable by the convex polyhedral optimization unit 120. A description “do-parallel” at line 7 indicates parallelization of the loops.

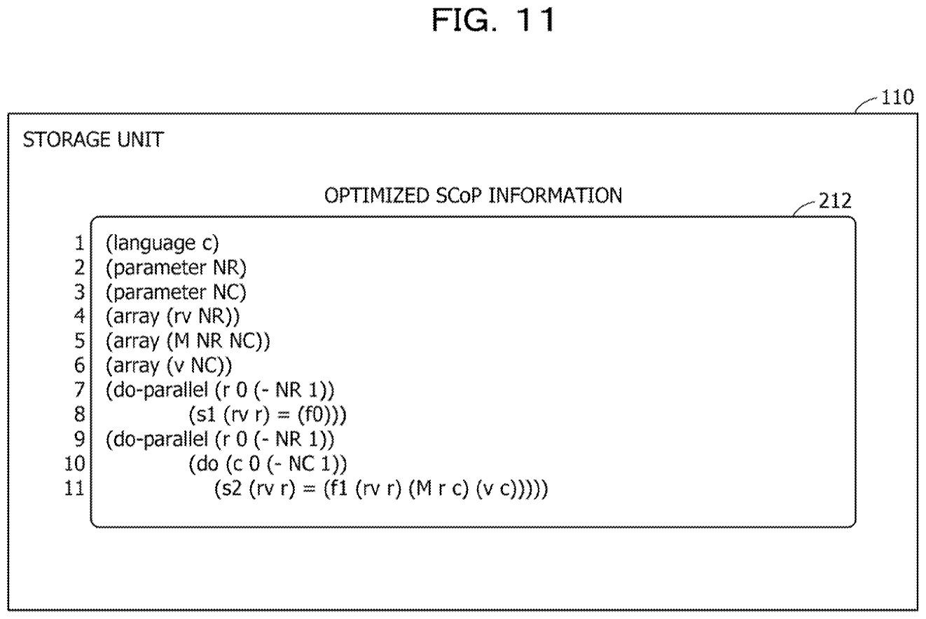

FIG. 11 is a diagram illustrating a second example of the optimized SCoP information.

Optimized SCoP information 212 is a result obtained when loop fission optimization for separating the statement s1 in a different loop is applied and the two loops at the top level are determined to be parallelizable by the convex polyhedral optimization unit 120.

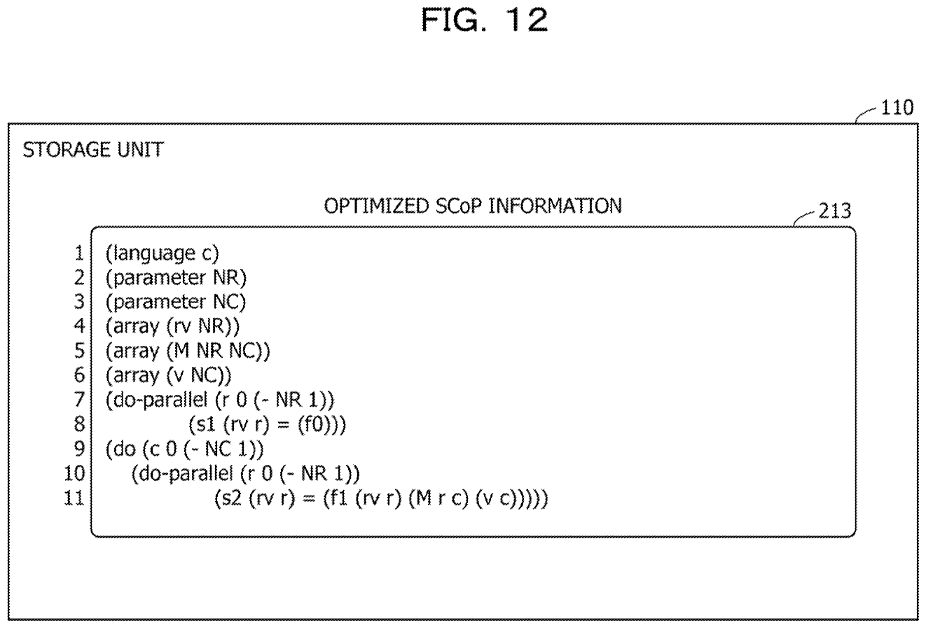

FIG. 12 is a diagram illustrating a third example of the optimized SCoP information.

Optimized SCoP information 213 is a result obtained when the convex polyhedral optimization unit 120 applies loop fission optimization similar to that applied to the optimized SCoP information 212 and applies loop interexchange optimization to a loop including the statement s2. In addition, the first loop at the top level and the inside of the second loop are determined to be parallelizable by the convex polyhedral optimization unit 120.

The optimized SCoP information 211, the optimized SCoP information 212, the optimized SCoP information 213 are elements of the optimized SCoP information set 210. Next, a procedure of the use possibility determination performed on each element of the optimized SCoP information set 210 will be described.

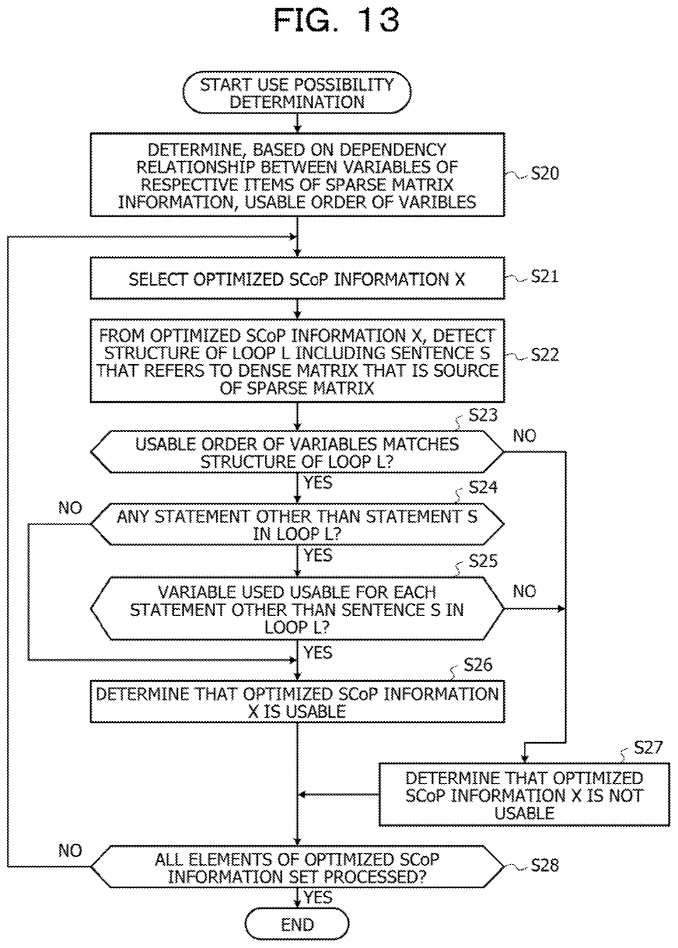

FIG. 13 is a flowchart illustrating an example of the use possibility determination.

The use possibility determination corresponds to step S12.

(S20) The code generation unit 130 detects a dependency relationship between variables of respective items of the sparse matrix information 220, and determines a usable order of the variables.

(S21) The code generation unit 130 selects optimized SCoP information X serving as a processing target from among the optimized SCoP information set 210.

(S22) The code generation unit 130 detects, from the optimized SCoP information X, a structure of a loop L including a statement S that refers to the dense matrix that is the source of the sparse matrix.

(S23) The code generation unit 130 determines whether or not the usable order determined in step S20 matches the structure of the loop L detected in step S22. If the usable order matches the structure of the loop L, the code generation unit 130 causes the processing to proceed to step S24. If the usable order does not match the structure of the loop L, the code generation unit 130 causes the processing to proceed to step S27. In a case where the usable order determined in step S20 indicates creation of a special loop, the code generation unit 130 determines in step S23 that the usable order matches the structure of the loop L and causes the processing to proceed to step S24. A specific example in the case where the usable order of the variables indicates creation of a special loop will be described later.

(S24) The code generation unit 130 determines whether or not there is any statement other than the statement S in the loop L. If there is a statement other than the statement S in the loop L, the code generation unit 130 causes the processing to proceed to step S25. If there is no statement other than the statement S in the loop L, the code generation unit 130 causes the processing to proceed to step S26.

(S25) For each statement other than the statement S in the loop L, the code generation unit 130 determines whether or not the variable used is usable. If the variable used is usable for each statement other than the statement S in the loop L, the code generation unit 130 causes the processing to proceed to step S26. If the variable used is not usable for any statement other than the statement S in the loop L, for example, if there is a variable not usable, the code generation unit 130 causes the processing to proceed to step S27.

(S26) The code generation unit 130 determines that the optimized SCoP information X is usable, and adds the optimized SCoP information X to the set SET. The code generation unit 130 then causes the processing to proceed to step S28.

(S27) The code generation unit 130 determines that the optimized SCoP information X is not usable and discards the optimized SCoP information X. The code generation unit 130 then causes the processing to proceed to step S28.

(S28) The code generation unit 130 determines whether or not all the elements of the optimized SCoP information set 210 have been processed. If all the elements of the optimized SCoP information set 210 have been processed, the code generation unit 130 ends the use possibility determination. If all the elements of the optimized SCoP information set 210 have not been processed, the code generation unit 130 causes the processing to proceed to step S21.

A specific example of the use possibility determination will be described next. First, an example of the sparse matrix information 220 will be described. As the sparse matrix information 220, information corresponding to a to-be-used format such as the CSR format, the CSC format, or the COO format is stored in the storage unit 110 in advance. As an example, the sparse matrix information 220 in a case of using the CSR format is exemplified.

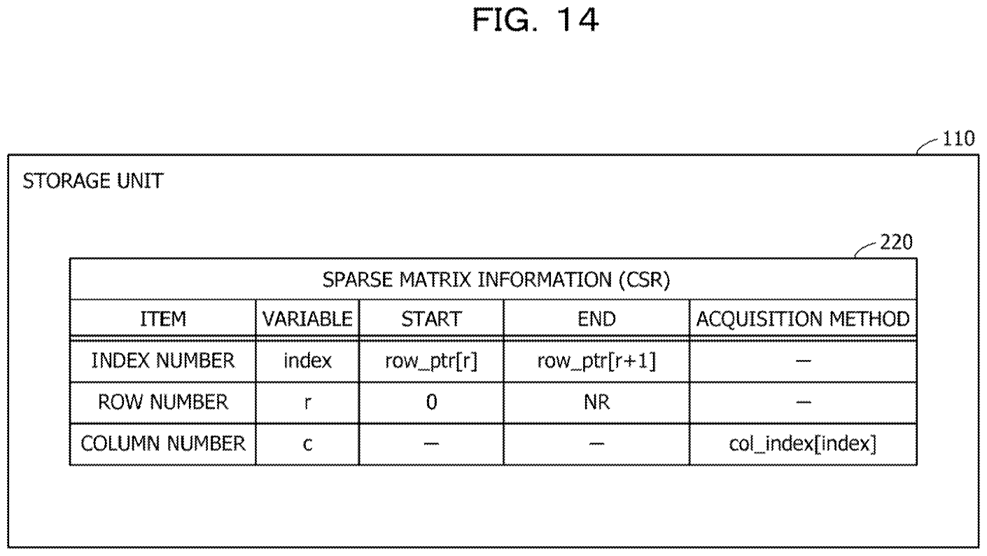

FIG. 14 is a diagram illustrating an example of sparse matrix information (CSR).

The sparse matrix information 220 indicates a relationship between an index number in the case of using the CSR format in representation of the sparse matrix, and a row number and a column number in the sparse matrix. This index number is a variable used for acquiring, from a row number, a non-zero element of the sparse matrix and a column number of this element. The index number may also be used as a loop variable for controlling a loop.

The sparse matrix information 220 includes fields “item”, “variable”, “start”, “end”, and “acquisition method”. In the field “item”, content represented by a variable is registered. In the field “variable”, a variable name used in the source code for this content is registered. In the field “start”, a start value of a loop corresponding to this variable is registered. In the field “end”, an end value of the loop corresponding to this variable is registered. However, in a case where the range of the value is not explicitly defined, no setting is made in the fields “start” and “end”. In FIG. 14, a hyphen “-” indicates that no setting is made. In the field “acquisition method”, a method for acquiring a value of this variable is set in a case where no setting is made in the fields “start” and “end”. For example, in the field “acquisition method”, another variable that represents a value to be substituted for this variable is set. In a case where settings are made in the fields “start” and “end”, no setting is made in the field “acquisition method”.

For example, the sparse matrix information 220 has a record with the item “index number”, the variable “index”, the start “row_ptr[r]”, the end “row_ptr[r+1]”, and the acquisition method “-”. This record indicates that “index” is used as the variable name that represents the index number and the start and the end of “index” are “row_ptr[r]” and “row_ptr[r+1]”, respectively, in the target source code.

The sparse matrix information 220 also has a record with the item “row number”, the variable “r”, the start “0”, the end “NR”, and the acquisition method “-”. This record indicates that “r” is used as the variable name that represents the row number in the sparse matrix and the start and the end of “r” are “0” and “NR”, respectively, in the target source code.

The sparse matrix information 220 further has a record with the item “column number”, the variable “c”, the start “-”, the end “-”, and the acquisition method “col_index[index]”. This record indicates that “c” is used as the variable name that represents the column number in the sparse matrix and the acquisition method of “c” is “col_index[index]” in the target source code.

For example, the code generation unit 130 obtains the following dependency relationship, based on the sparse matrix information 220. The code generation unit 130 detects that the variable “r” indicating the row number is dependent on none of the variables “index” and “c” in the sparse matrix information 220, the value is directly substituted for the variable r, and the start value and the end value of the loop may be designated for the variable r. The code generation unit 130 also detects that the variable “index” indicating the index number is dependent on the variable “r”, the value is indirectly substituted in accordance with the variable “r”, and the start value and the end value of the loop may be designated for the variable “index”. The code generation unit 130 further detects that the variable “c” indicating the column number is dependent on the variable “index” in the sparse matrix information 220, the value is indirectly substituted in accordance with the variable “index”, and the start value and the end value of the loop may not be designated for the variable “c”. As described above, the sparse matrix information 220 indicates the dependency relationship between the variables that represent the sparse matrix in the target source code. This dependency relationship is used in the use possibility determination (described below) performed by the code generation unit 130 and generation of an optimized program code candidate (described later).

As an example, the use possibility determination for the optimized SCoP information 211, the optimized SCoP information 212, and the optimized SCoP information 213 in a case of using the sparse matrix information 220 will be described.

First, in step S20, the code generation unit 130 determines the usable order of the variables from the sparse matrix information 220. The variables in the sparse matrix information 220 are three variables “index”, “r”, and “c”. Because the variable “index” uses the variable “r” in the fields “start” and “end”, the variable “index” is dependent on the variable “r”. Because the variable “c” uses the variable “index” in the field “acquisition method”, the variable “c” is dependent on the variable “index”. The variable “r” is not dependent on the other variables. Thus, the code generation unit 130 determines the usable order of the variables to be (r, index, c). “(r, index, c)” indicates that the variables are usable in an order from left to right.

Next, the code generation unit 130 selects the optimized SCoP information 211 as the optimized SCoP information X that is the processing target. A selection order of the optimized SCoP information X may be arbitrary. In the optimized SCoP information 211, the statement that refers to the dense matrix that is the source of the sparse matrix, for example, the two-dimensional array M is the statement s2. Thus, the code generation unit 130 detects (r, c) as a loop structure that includes the statement s2 identified in step S22. As for the order of the variables indicated by the loop structure, “r” comes first as an outer loop, and “c” comes next as an inner loop in both cases. Thus, the code generation unit 130 determines that the loop structure matches, for example, coincides with the usable order of the variables in the sparse matrix information 220, and determines YES in step S23.

Next, in step S24, the code generation unit 130 detects the statement s1 in the loop including the statement s2. In step S25, the code generation unit 130 determines a use possibility on the variable r used in the statement s1. In the sparse matrix information 220, each of the start and the end is defined for the variable r. Thus, the code generation unit 130 determines that the variable r used in the statement s1 is usable. In step S26, the code generation unit 130 determines that the optimized SCoP information 211 is usable for the sparse matrix information 220, and adds the optimized SCoP information 211 to the set SET.

In a case of using the sparse matrix information 220 for the optimized SCoP information 212, since the statement s1 is present in a loop different from a loop in which the statement s2 is present, the code generation unit 130 determines No in step S24 and determines that the optimized SCoP information 212 is usable.

In a case of using the sparse matrix information 220 for the optimized SCoP information 213, the code generation unit 130 determines that the optimized SCoP information 213 is not usable. This is because the loop structure including the statement s2 detected in step S22 for the optimized SCoP information 213 is (c, r), and this does not match the order of the variables r and c as compared with the usable order (r, index, c) of the variables.

The sparse matrix information 220 in the CSR format is exemplified in the above example. However, the CSC format, the COO format, or the like may be used. Accordingly, a case of using the CSC format and a case of using the COO format will be exemplified next. First, the case of using the CSC format will be described.

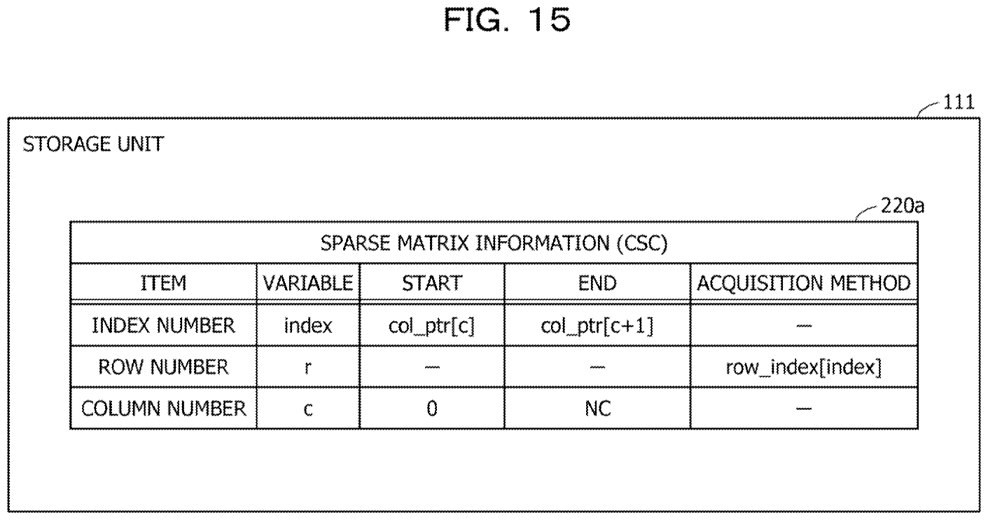

FIG. 15 is a diagram illustrating an example of sparse matrix information (CSC).

Sparse matrix information 220a indicates a relationship between an index number in a case of using the CSC format in representation of the sparse matrix, and a row number and a column number in the sparse matrix. This index number is a variable used for acquiring, from a column number, a non-zero element of the sparse matrix and a row number of this element. The sparse matrix information 220a has substantially the same fields as those of the sparse matrix information 220.

For example, the sparse matrix information 220a has a record with the item “index number”, the variable “index”, the start “col_ptr[c]”, the end “col_ptr[c+1]”, and the acquisition method “-”. This record indicates that “index” is used as the variable name that represents the index number and the start and the end of “index” are “col_ptr[c]” and “col_ptr[c+1]”, respectively, in the target source code.

The sparse matrix information 220a also has a record with the item “row number”, the variable “r”, the start “-”, the end “-”, and the acquisition method “row_index[index]”. This record indicates that “r” is used as the variable name that represents the row number in the sparse matrix and the acquisition method of “r” is “row_index[index]” in the target source code.

The sparse matrix information 220a further has a record with the item “column number”, the variable “c”, the start “0”, the end “NC”, and the acquisition method “-”. This record indicates that “c” is used as the variable name that represents the column number in the sparse matrix and the start and the end of “c” are “0” and “NC”, respectively, in the target source code.

As an example, the use possibility determination for the optimized SCoP information 211, the optimized SCoP information 212, and the optimized SCoP information 213 in a case of using the sparse matrix information 220a will be described.

Because the usable order (c, index, r) of the variables determined from the sparse matrix information 220a does not match the loop structure (r, c) of the optimized SCoP information 211, the code generation unit 130 determines that the optimized SCoP information 211 is not usable.

Because the usable order (c, index, r) of the variables determined from the sparse matrix information 220a does not match the loop structure (r, c) of the optimized SCoP information 212, the code generation unit 130 determines that the optimized SCoP information 212 is not usable.

For the optimized SCoP information 213, the code generation unit 130 determines that the usable order (c, index, r) of the variables determined from the sparse matrix information 220a matches the loop structure (c, r) of the optimized SCoP information 213. In the optimized SCoP information 213, the statement s1 and the statement s2 are separated in different loops. Thus, the code generation unit 130 determines that the optimized SCoP information 213 is usable for the sparse matrix information 220a.

Next, the case of using the COO format will be described.

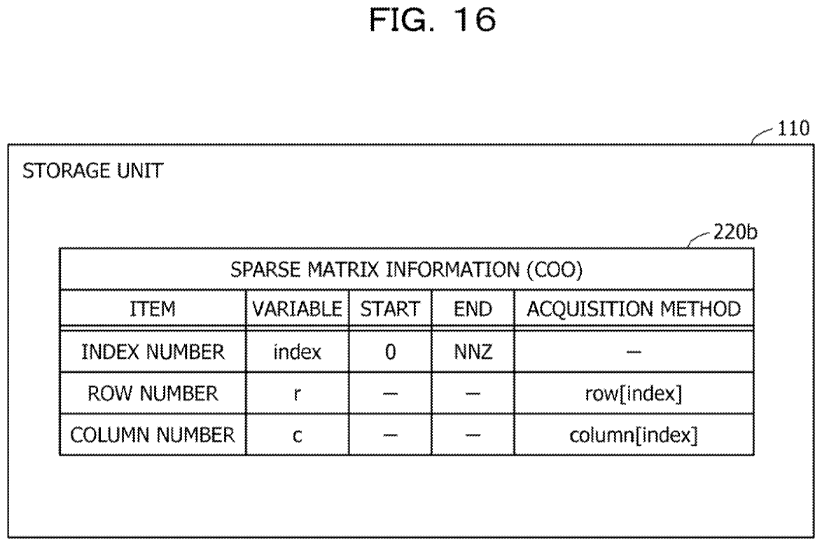

FIG. 16 is a diagram illustrating an example of sparse matrix information (COO).

Sparse matrix information 220b indicates a relationship between an index number in a case where the COO format is used in representation of the sparse matrix, and a row number and a column number in the sparse matrix. This index number is a variable used for acquiring the row number and the column number of a non-zero element of the sparse matrix. The sparse matrix information 220b has substantially the same fields as those of the sparse matrix information 220.

For example, the sparse matrix information 220b has a record with the item “index number”, the variable “index”, the start “0”, the end “NNZ”, and the acquisition method “-”. This record indicates that “index” is used as the variable name that represents the index number and the start and the end of “index” are “0” and “NNZ”, respectively, in the target source code.

The sparse matrix information 220b also has a record with the item “row number”, the variable “r”, the start “-”, the end “-”, and the acquisition method “row[index]”. This record indicates that “r” is used as the variable name that represents the row number in the sparse matrix and the acquisition method of “r” is “row[index]” in the target source code.

The sparse matrix information 220b further has a record with the item “column number”, the variable “c”, the start “-”, the end “-”, and the acquisition method “column[index]”. This record indicates that “c” is used as the variable name that represents the column number in the sparse matrix and the acquisition method of “c” is “column[index]” in the target source code.

As an example, the use possibility determination for the optimized SCoP information 211, the optimized SCoP information 212, and the optimized SCoP information 213 in a case of using the sparse matrix information 220b will be described. In the case of the sparse matrix information 220b, the usable order of the variables is (index, (r|c)). This usable order indicates that both the variables r and c are generated at the same time from the variable index, for example, means creation of a special loop that does not constitute loops involving the variables r and c. Thus, the code generation unit 130 does not determine No in step S23 for any of the optimized SCoP information 211, the optimized SCoP information 212, and the optimized SCoP information 213.

However, a loop of the variable r for the statement s1 may not be created with the optimized SCoP information 211. For example, the start/end is not set for the variable r in the sparse matrix information 220b, and thus the variable r is not usable for loop control for the statement s1. Thus, the code generation unit 130 determines No in step S25 and determines that the optimized SCoP information 211 is not usable. On the other hand, the code generation unit 130 determines that the optimized SCoP information 212 and the optimized SCoP information 213 are usable. However, since a special loop that is not dependent on the order of the variable r and the variable c is created for the loop of the variable r and the loop of the variable c, there is no longer a difference between the optimized SCoP information 212 and the optimized SCoP information 213. Thus, both the optimized SCoP information 212 and the optimized SCoP information 213 consequently are converted into the same optimized program code candidate through code conversion. At this time, since the loop of the variable r is not present, parallelization is no longer applicable. An example of an optimized program code candidate generated for the optimized SCoP information 212 and the optimized SCoP information 213 in the case of using the sparse matrix information 220b will be described later.

Next, a procedure of generating an optimized program code candidate set will be described.

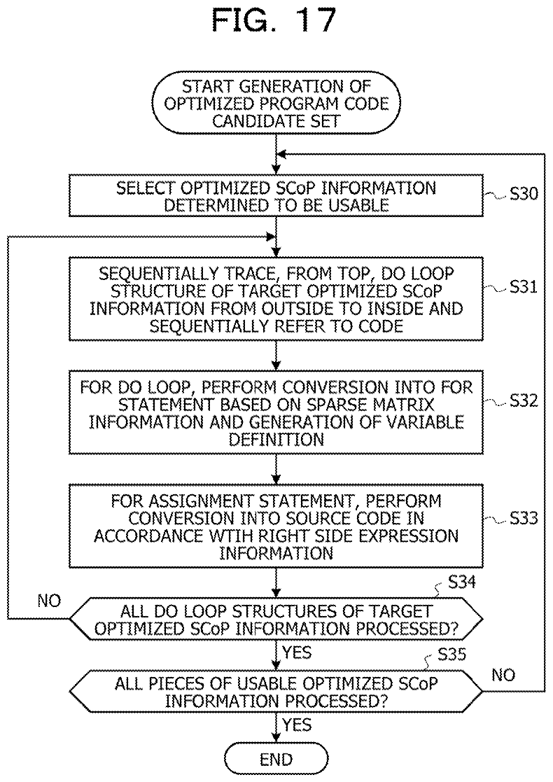

FIG. 17 is a flowchart illustrating an example of generation of an optimized program code candidate set.

Generation of the optimized program code candidate set corresponds to step S13.

(S30) The code generation unit 130 selects one piece of optimized SCoP information determined to be usable for the sparse matrix information 220 in the procedure in FIG. 13. For example, the code generation unit 130 selects one piece of optimized SCoP information Y that serves as the processing target from the set SET.

(S31) The code generation unit 130 sequentially traces, from the top, a do loop structure of the target optimized SCoP information Y from the outside to the inside and sequentially refers to the code. The code to be referred to includes do loops and assignment statements such as the statements s1 and s2. The code generation unit 130 performs step S32 and S33 (described below) in the process of sequentially tracing the code.

(S32) For the do loop, the code generation unit 130 performs conversion into a for statement based on the sparse matrix information 220 and generation of a variable definition based on the data type information 240. At this time, the code generation unit 130 may apply data specialization, based on the sparse matrix specialization information 250.

(S33) For each assignment statement, the code generation unit 130 performs conversion into a source code in accordance with the right side expression information 230. At this time, the code generation unit 130 converts a variable (for example, the array M) of the dense matrix that is the source of the sparse matrix into a variable (for example, the array SM) of the sparse matrix.

The code generation unit 130 may apply data specialization based on the sparse matrix specialization information 250. For data that is not included in the sparse matrix information 220 and the sparse matrix specialization information 250, the code generation unit 130 converts the data into the source code as it is by using the data of the optimized SCoP information Y.

(S34) The code generation unit 130 determines whether or not all the do loop structures of the target optimized SCoP information Y have been processed. If all the do loop structures of the optimized SCoP information Y have been processed, the code generation unit 130 adds the generated optimized program code candidate to the optimized program code candidate set 270, and causes the processing to proceed to step S35. If there is an unprocessed do loop structure in the optimized SCoP information Y, the code generation unit 130 causes the processing to proceed to step S31. Then, the code generation unit 130 selects the next do loop structure in step S31 and proceeds the procedure.

(S35) The code generation unit 130 determines whether or not all pieces of optimized SCoP information usable for the sparse matrix information 220, for example, all pieces of optimized SCoP information included in the set SET have been processed. If all the pieces of usable optimized SCoP information have been processed, the code generation unit 130 ends generation of the optimized program code candidate set. If all the pieces of usable optimized SCoP information have not been processed, the code generation unit 130 causes the processing to proceed to step S30.

A specific example of generation of the optimized program code candidate set by the code generation unit 130 will be described next.

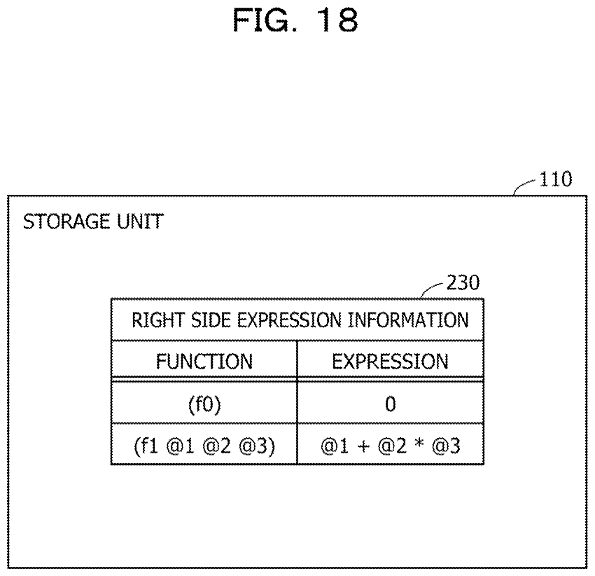

FIG. 18 is a diagram illustrating an example of right side expression information.

The right side expression information 230 includes fields “function” and “expression”. In the field “function”, the function name written in the optimized SCoP information is registered. In the field “function”, an argument is sometimes registered together with the function name. In the field “expression”, an expression corresponding to the function name is registered. The expression includes a constant.

For example, the right side expression information 230 includes a record with the function “f0” and the expression “0”. This record indicates that the function “(f0)” included in the optimized SCoP information is converted into 0.

The right side expression information 230 includes a record with the function “(f1 @1 @2 @3)” and the expression “@1+@2*@3”. This record indicates that the function “(f1 @1 @2 @3)” included in the optimized SCoP information is converted into the expression “@1+@2*@3”. “@1”, “@2”, and “@3” represent arguments of the function. For example, in the optimized SCoP information 211, there is a description (f1(rv r)(M r c)(v c)) at line 10. In this case, (rv r) corresponds to the argument “@1”. (M r c) corresponds to the argument “@2”. (v c) corresponds to the argument “@3”.

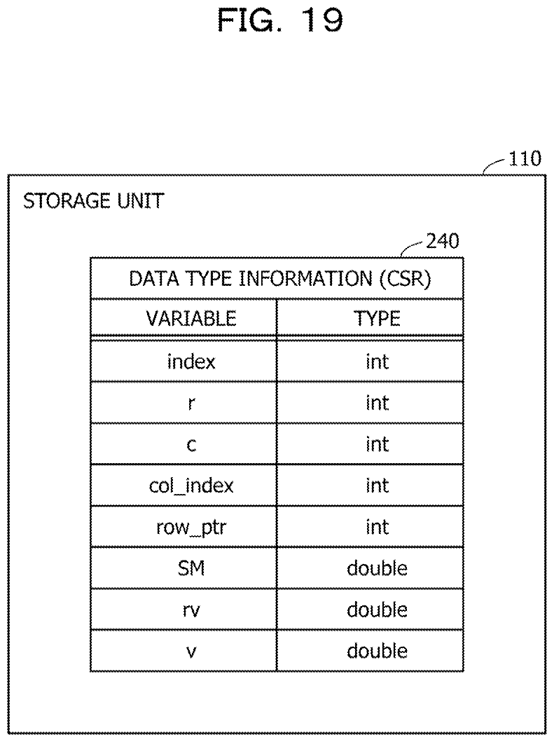

FIG. 19 illustrates an example of data type information.

The data type information 240 is for the CSR format. In a case where another format such as the CSC format is used, data type information conforming to this format is stored in the storage unit 110 in advance.

The data type information 240 includes fields “variable” and “type”. In the field “variable”, a variable used in the target source code is registered. In the field “type”, a type of the variable is registered. For example, the data type information 240 has a record with the variable “index” and the type “int”. This record indicates that the type of the variable “index” is “int”. The data type information 240 also holds records indicating types of the other variables.

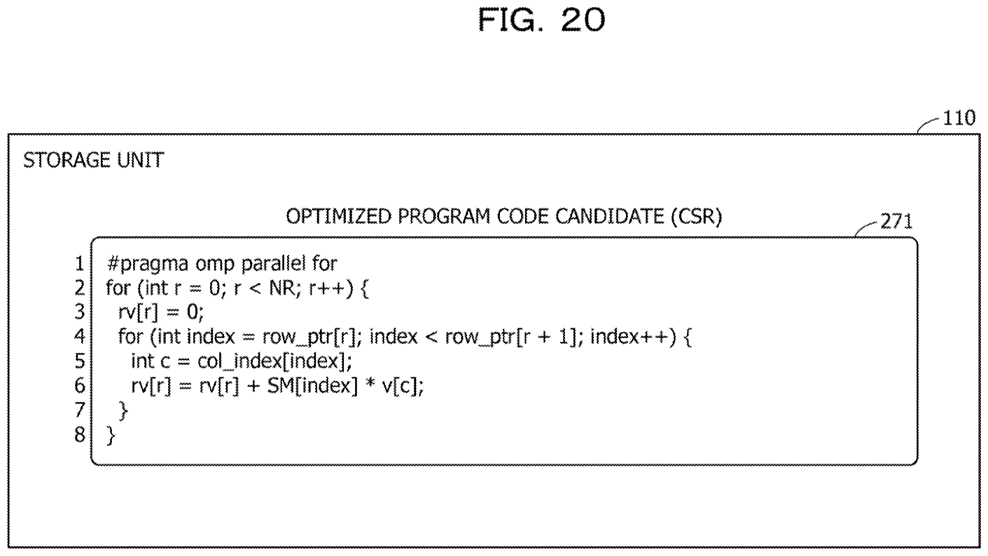

FIG. 20 is a diagram illustrating a first example of an optimized program code candidate.

An optimized program code candidate 271 is an element of the optimized program code candidate set 270. The optimized program code candidate 271 is generated for the sparse matrix information 220 and the optimized SCoP information 211. For example, the code generation unit 130 converts the optimized SCoP information 211 into the optimized program code candidate 271 in the following manner.

The code generation unit 130 processes the first do loop (1) below at lines 7 to 10 of the optimized SCoP information 211.

(do-parallel (r 0 (− NR 1))
...
) ... (1)

This do loop is a parallelization loop. Thus, by using the sparse matrix information 220, the code generation unit 130 converts the first do loop (1) into a loop (1a) in a following format.

#pragma omp parallel for
for (int r = 0; r < NR; r++) {
...
} ... (1a)

Next, the code generation unit 130 processes an assignment statement (2) below at line 8 of the optimized SCoP information 211.

(s1(rv r)=(f0)) (2)

The left side is a vector reference. The right side is an expression of the value 0 of the right side expression information 230. Thus, the code generation unit 130 converts this assignment statement into a code (2a) below.

rv[r]=0; (2a)

Next, the code generation unit 130 processes an inner do loop (3) below at lines 9 to 10 of the optimized SCoP information 211.

(do (c 0 (− NC 1))
...
) ... (3)

This inner do loop is a loop of the variable c. However, in the sparse matrix information 220, no setting is made for the start and the end of the variable c. Thus, a loop may not be directly formed. Thus, the code generation unit 130 generates a loop using “index” instead of “c” for the inner do loop above, and converts the inner do loop (3) into a loop (3a) in a following format that extracts “c” from “index”.

int start = row_ptr[r];
int end = row_ptr[r+1];
for (int index = start; index < end; index++){
int c = col_index[index];
...
} ... (3a)

At this time, the code generation unit 130 uses the data type information 240 for the type of the variable. As indicated by the optimized program code candidate 271, the code generation unit 130 may employ a description not using the variable “start” and the variable “end” above.

Lastly, the code generation unit 130 processes a remaining assignment statement (4) at line 10 of the optimized SCoP information 211.

(s2(rv r)=(f1(rv r)(M r c)(v c))) (4)

According to the right side expression information 230, the right side is multiplication and addition of data. The code generation unit 130 detects that M indicates the original dense matrix of the sparse matrix, and performs conversion into the array SM corresponding to the sparse matrix based on the sparse matrix information 220. In this manner, the code generation unit 130 obtains a code (4a) below.

rv[r]=rv[r]+SM[index]*v[c]; (4a)

As a result of the code conversion described above, the code generation unit 130 generates the optimized program code candidate 271. An illustration of definition statements written outside the loop for some variables included in the data type information 240 is omitted in the optimized program code candidate 271. The same applies to the description below.

For the optimized SCoP information 212 determined to be usable for the sparse matrix information 220, the code generation unit 130 generates an optimized program code candidate through substantially the same code conversion.

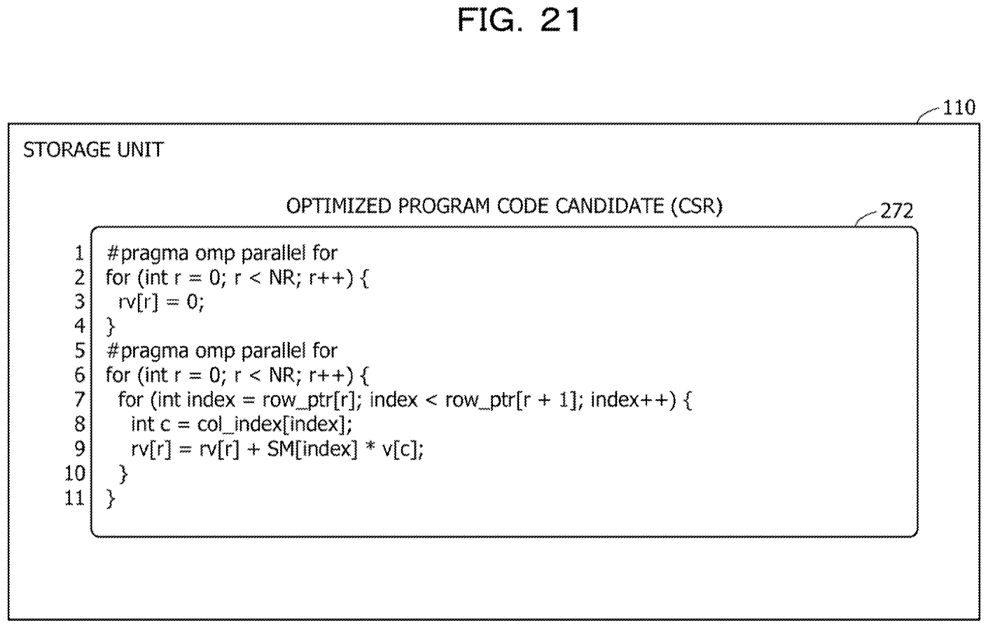

FIG. 21 is a diagram illustrating a second example of the optimized program code candidate.

An optimized program code candidate 272 is generated through code conversion performed by the code generation unit 130, based on the optimized SCoP information 212 determined to be usable for the sparse matrix information 220.

Because the optimized SCoP information 213 is determined to be not usable for the sparse matrix information 220, the code generation unit 130 does not perform code conversion on the optimized SCoP information 213. Thus, in this case, the elements of the optimized program code candidate set 270 are two candidates that are the optimized program code candidates 271 and 272.

The optimized program selection unit 140 evaluates each element of the optimized program code candidate set 270. For example, as a result of compiling and executing each of the optimized program code candidates 271 and 272, the optimized program selection unit 140 evaluates that the optimized program code candidate 271 has higher performance. Then, the optimized program selection unit 140 adds the optimized program code candidate 271 to the optimized program code set 290. In this case, the optimized program code candidate 271 is an optimized source code finally selected.

If the processing performance of the optimized program code candidate 271 and the processing performance of the optimized program code candidate 272 are approximately the same, there is a possibility that a difference is caused in the case of other sparse matrix data. Thus, the optimized program selection unit 140 adds both the optimized program code candidates 271 and 272 to the optimized program code set 290. In this case, both the optimized program code candidates 271 and 272 are the optimized source codes finally selected. The optimized program selection unit 140 outputs the optimized program code set 290.

In the description above, the case of using the sparse matrix information 220 for the CSR format has been mainly described. However, sparse matrix information for another format such as the sparse matrix information 220a for the CSC format or the sparse matrix information 220b for the COO format may be used as described above. Optimized program code candidates generated in cases of using the sparse matrix information 220a and the sparse matrix information 220b will be exemplified.

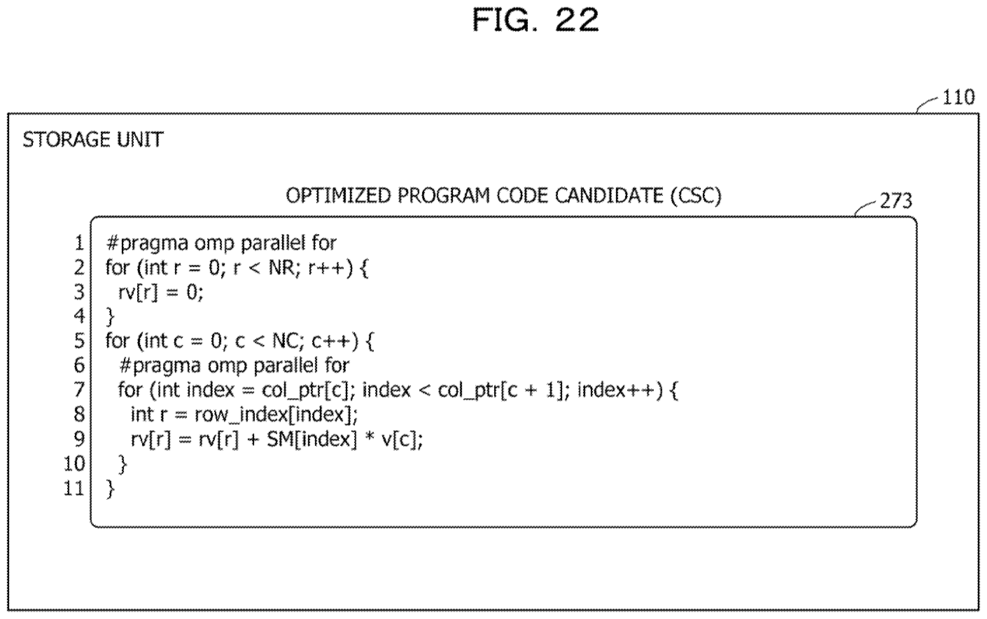

FIG. 22 is a diagram illustrating a third example of the optimized program code candidate.

An optimized program code candidate 273 is generated through code conversion performed by the code generation unit 130, based on the optimized SCoP information 213 determined to be usable for the sparse matrix information 220a.

As described above, among the optimized SCoP information 211, the optimized SCoP information 212, and the optimized SCoP information 213, only the optimized SCoP information 213 is determined to be usable for the sparse matrix information 220a. In this case, the optimized program selection unit 140 may skip the performance evaluation and add the optimized program code candidate 273 generated based on the optimized SCoP information 213 to the optimized program code set 290. Alternatively, the optimized program selection unit 140 may perform performance evaluation for the optimized program code candidate 273. If the result of this evaluation satisfies the minimum performance to be satisfied, the optimized program selection unit 140 may add the optimized program code candidate 273 to the optimized program code set 290. For example, in a case where the optimized program code set 290 is an empty set, the optimized program selection unit 140 may notify the user to change or the like an option of optimization performed by the convex polyhedral optimization unit 120 and may prompt the user to start over from the convex polyhedral optimization.

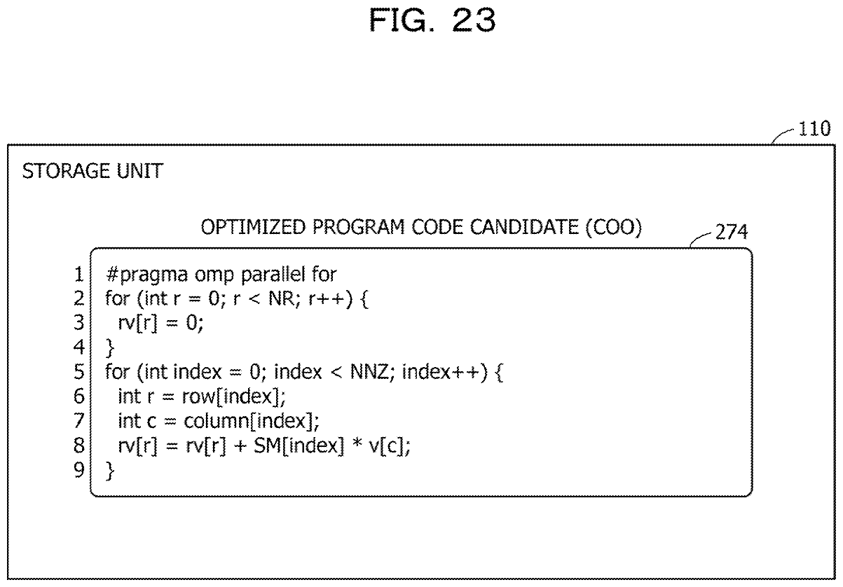

FIG. 23 is a diagram illustrating a fourth example of the optimized program code candidate.

An optimized program code candidate 274 is generated through code conversion performed by the code generation unit 130, based on the optimized SCoP information 213 determined to be usable for the sparse matrix information 220b.

The optimized SCoP information 213 includes a do loop (5) below at lines 9 to 11.

(do (c 0 (− NC 1))
(do-parallel (r 0 (− NR 1))
...
)) ... (5)

Neither the start nor the end are set for any of the variables c and r in the sparse matrix information 220b. Thus, the code generation unit 130 converts the do loop (5) into a loop (5a) in a following format.

for (int index = 0; index < NNZ; index++){
int r = row[index];
int c = column[index];
...
} ... (5a)

As a result of code conversion including the conversion above, the code generation unit 130 generates the optimized program code candidate 274.

As described in steps S32 and S33, the code generation unit 130 may perform data specialization based on the sparse matrix specialization information 250 in the process of generating the optimized program code candidate. Accordingly, data specialization will be described next.

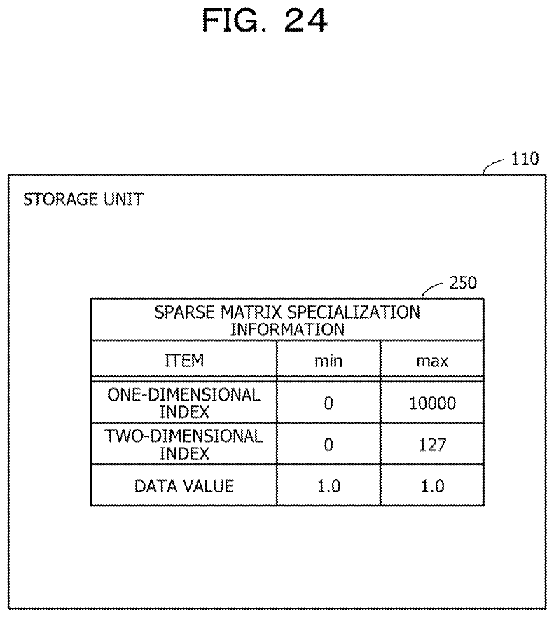

FIG. 24 is a diagram illustrating an example of sparse matrix specialization information.

The sparse matrix specialization information 250 includes fields “item”, “min”, and “max”. In the field “item”, an identification name indicating data that is a specialization target is registered. In the field “min”, a minimum value of this data is registered. In the field “max”, a maximum value of this data is registered. When the minimum value and the maximum value are the same value, it is indicated that this data a constant.

For example, the sparse matrix specialization information 250 has a record with the item “one-dimensional index”, the min “0”, and the max “10000”. This record indicates that a range of the one-dimensional index, for example, the index indicating the row number is greater than or equal to 0 and less than 10000.

The sparse matrix specialization information 250 also has a record with the item “two-dimensional index”, the min “0”, and the max “127”. This record indicates that a range of the two-dimensional index, for example, the index corresponding to the column number is greater than or equal to 0 and less than 127.

The sparse matrix specialization information 250 further has a record with the field “data value”, the min “1.0”, and the max “1.0”. This record indicates that all data values of the elements of the sparse matrix are 1.0.

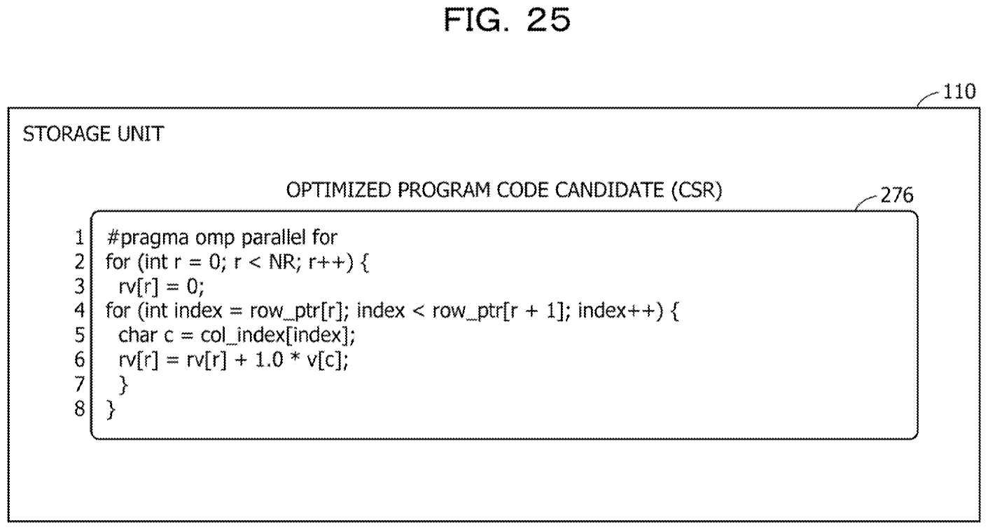

FIG. 25 is a diagram illustrating a sixth example of the optimized program code candidate.

An optimized program code candidate 276 is generated by the code generation unit 130, based on the optimized SCoP information 211, the sparse matrix information 220, the right side expression information 230, the data type information 240, and the sparse matrix specialization information 250. The code generation unit 130 generates the optimized program code candidate 276 instead of the optimized program code candidate 271.

For example, the code generation unit 130 uses the fact that the two-dimensional index has in a value range covered by one byte, based on the sparse matrix specialization information 250. For example, the code generation unit 130 generates “char c=col_index [index];” instead of “int c=col_index [index];” at line 5 of the optimized program code candidate 271.

The code generation unit 130 uses the fact that data values of the sparse matrix are only 1.0, based on the sparse matrix specialization information 250. For example, the code generation unit 130 generates “rv[r]=rv[r]+1.0*v[c]” instead of “rv[r]=rv[r]+SM[index] v[c]” at line 6 of the optimized program code candidate 271.

As a result, the code generation unit 130 obtains the optimized program code candidate 276. By generating the optimized program code candidate 276, the code generation unit 130 may speed up the sparse matrix processing as compared with the case of using the optimized program code candidate 271.

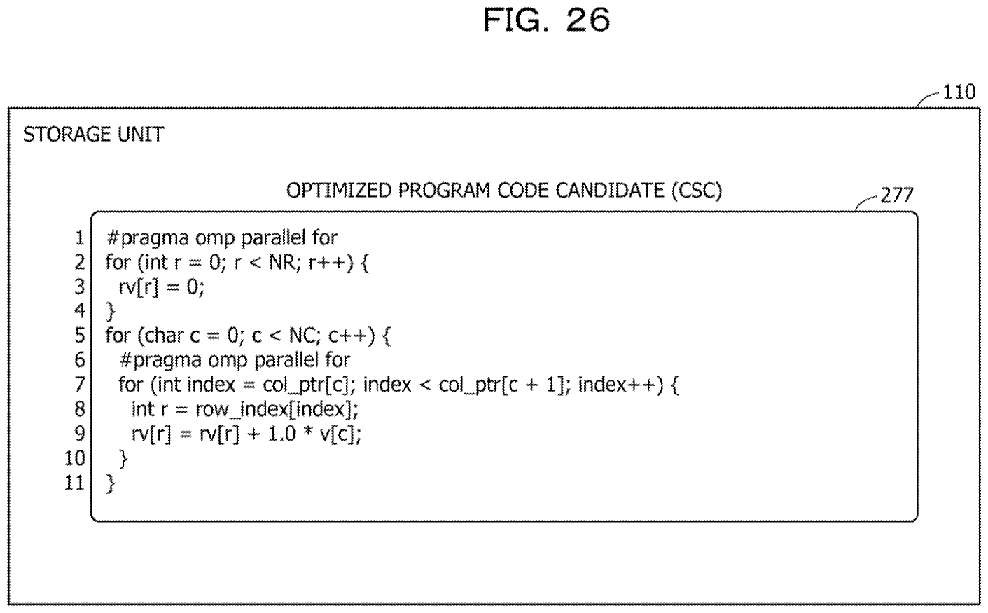

FIG. 26 is a diagram illustrating a seventh example of the optimized program code candidate.

An optimized program code candidate 277 is an example of an optimized program code candidate generated by the code generation unit 130, based on the optimized SCoP information 212, the sparse matrix information 220a, the right side expression information 230, the data type information, and the sparse matrix specialization information 250. As the data type information, the data type information for the CSC format is used instead of the data type information 240 for the CSR format.

The code generation unit 130 may generate the optimized program code candidate set 270, based on the optimization strategy instruction information 260 in addition to the optimized SCoP information set 210, the sparse matrix information 220, the right side expression information 230, the data type information 240, and the sparse matrix specialization information 250.

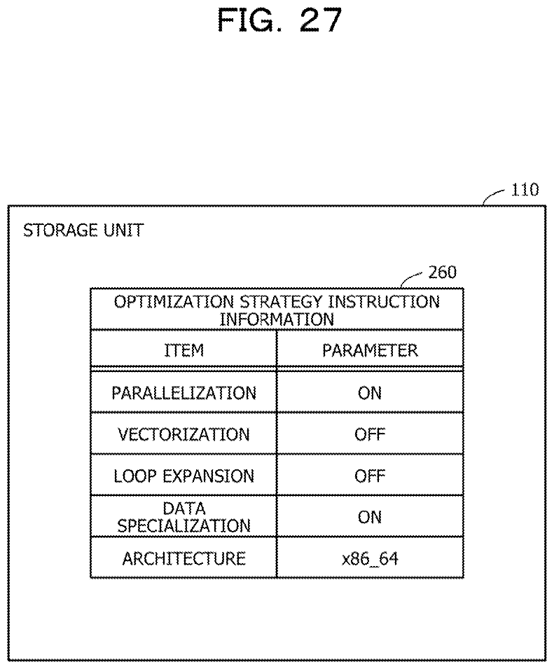

FIG. 27 is a diagram illustrating an example of optimization strategy instruction information.

The optimization strategy instruction information 260 includes fields “item” and “parameter”. In the field “item”, an item that is an optimization target is registered. In the field “parameter”, information that indicates whether or not to perform optimization on the target item is registered.

For example, the optimization strategy instruction information 260 has a record with the item “parallelization” and the parameter “ON”. This record indicates that parallelization is used.

The optimization strategy instruction information 260 has a record with the item “vectorization” and the parameter “OFF”. This record indicates that vectorization is not used. Likewise, the optimization strategy instruction information 260 has a record indicating that loop expansion is not used.

The optimization strategy instruction information 260 has a record with the item “data specialization” and the parameter “ON”. This record indicates that data specialization based on the sparse matrix specialization information 250 is used.

The optimization strategy instruction information 260 further has a record with the item “architecture” and the parameter “x86_64”. This record indicates that an instruction set architecture of a computer that performs processing based on the target source code is “x86_64” and optimization according to this instruction set architecture is used.

As described above, the information processing apparatus 100 allows the user to input an optimization strategy instruction via the optimization strategy instruction information 260. For example, the user may instruct the information processing apparatus 100 of whether or not to use data specialization by setting data specialization on or off in the optimization strategy instruction information 260. Thus, the information processing apparatus 100 may more efficiently generate the optimized program code suitable for a user environment.

There is a possibility that execution of the program may be speeded up by reducing an amount of data transferred between the RAM 102 and the CPU 101 by using the sparse matrix. On the other hand, since the source code gets complicated, it becomes difficult to apply optimization with a compiler. There is a possibility that the execution time of the program greatly changes depending on how zeros are distributed in the sparse matrix. For example, there is a problem that it is difficult to efficiently use a cache and it becomes difficult to tune the program.

Because a source code of sparse matrix processing includes use of a pointer and an indirect reference to data, it is difficult to perform optimization with a compiler. Accordingly, an optimized library is prepared in advance for various algorithms of the sparse matrix processing that may be written in a source code, and this library is sometimes utilized. However, the library prepared in advance is unable to cope with the just-in-time compilation method. In a case where the library prepared in advance does not conform to a data structure or an algorithm of the sparse matrix processing used by a program writer, optimization with the library is not applicable. Because the execution performance of the sparse matrix processing greatly depends on the target architecture, the library prepared in advance has to be updated every time a new-generation calculator becomes available. Thus, it is difficult to obtain the highest performance at an arbitrary time point.

Accordingly, as exemplified in the second embodiment, the information processing apparatus 100 automatically generates the optimized program code set 290 that is a set of optimized source codes. For example, the information processing apparatus 100 obtains the optimized SCoP information set 210 by optimizing the algorithm SCoP information 200 in which an algorithm of sparse matrix processing is written, instead of directly converting a source code into an optimized code. This allows the information processing apparatus 100 to use loop optimization using a convex polyhedral model that is not applicable to the source code in which the sparse matrix processing is written. By utilizing an existing tool for performing convex polyhedral optimization, the information processing apparatus 100 may easily use loop optimization based on convex polyhedral optimization.

Based on the sparse matrix information 220, the right side expression information 230, and the data type information 240, the information processing apparatus 100 converts the optimized SCoP information set 210 into the optimized program code candidate set 270 written in a predetermined programming language. In accordance with evaluation of the processing performance for an actual sparse matrix in a case where the optimized program code candidates are used, the information processing apparatus 100 selects the optimized program code set 290 from among the optimized program code candidate set 270.

Thus, the information processing apparatus 100 may efficiently obtain the optimized program code suitable for a user environment. For example, even if the data type used in the sparse matrix or the format of the right side of the assignment statement is changed in the algorithm SCoP information 200 as a result of omitting the data type and the specific information on the right side expression, an effect of loop optimization using a convex polyhedral model may be easily obtained. By executing an executable code obtained as a result of compiling the optimized program code and by performing the sparse matrix processing, the information processing apparatus 100 may reduce an amount of data transferred between a CPU and a memory such as a RAM and may speed up this sparse matrix processing.

As described above, the information processing apparatus 100 may cope with a wide range of optimization in which a combination of an algorithm of the sparse matrix processing, the sparse matrix format, the data type, the properties of the sparse matrix, the target architecture, and the optimization method is a parameter. The information processing apparatus 100 may apply optimization based on a convex polyhedral model to the sparse matrix algorithm. The information processing apparatus 100 may obtain an optimum source code suitable for the target architecture.

It may be said that the information processing apparatus 100 performs processing below.

The convex polyhedral optimization unit 120 acquires a plurality of second codes by optimizing, with a convex polyhedral model, a first code in which loop processing on a matrix is written in a static control part format. The code generation unit 130 converts the plurality of second codes into a plurality of source code candidates, based on sparse matrix information that indicates a variable that represents a non-zero element of a sparse matrix, expression information that indicates an operation expression that corresponds to a function included in the second codes, and data type information that indicates a type to be used for the variable. The optimized program selection unit 140 selects the source code from among the plurality of source code candidates in accordance with evaluation of processing performance for the sparse matrix in a case where each of the plurality of source code candidates is used.

Thus, the information processing apparatus 100 may efficiently obtain an optimized source code for the sparse matrix processing. The algorithm SCoP information 200 is an example of the first code. Each element of the optimized SCoP information set 210, for example, the optimized SCoP information is an example of the second code. Each element of the optimized program code candidate set 270, for example, the optimized program code candidate is an example of the source code candidate. Each element of the optimized program code set 290, for example, the optimized program code is an example of the source code selected from among the plurality of source code candidates.

For example, the sparse matrix information includes information that indicates a dependency relationship between a plurality of variables used in the target source code in accordance with a representation format of the sparse matrix, the plurality of variables including a first variable that indicates an index for controlling the loop processing, a second variable that indicates a row number in the sparse matrix, and a third variable that indicates a column number in the sparse matrix. In the converting the plurality of second codes into the plurality of source code candidates, the code generation unit 130 converts a description of the loop processing included in the plurality of second codes into a code that uses the plurality of variables, based on the sparse matrix information.

Thus, the information processing apparatus 100 may efficiently generate source code candidates suitable for a representation format of the sparse matrix such as the CSR format or the CSC format. For example, as described above, based on the sparse matrix information, the code generation unit 130 acquires a dependency relationship between the variables including, for each of the variables used in the target source code candidate and representing the sparse matrix, whether or not a start value and an end value of a loop for the variable may be designated. The dependency relationship allows the code generation unit 130 to determine a description of the loop in the source code candidate and appropriately generate the source code candidate by using the description.

The code generation unit 130 may determine whether or not each of the plurality of second codes is usable for the sparse matrix information, based on the dependency relationship between the plurality of variables and a loop structure included in each of the plurality of second codes. The code generation unit 130 may convert the second code determined to be usable into a source code candidate.

As described above, by narrowing down the usable second codes, the information processing apparatus 100 may skip generation of a source code candidate for the second code that is apparently not usable and may make generation of the source code candidate more efficient. For example, the information processing apparatus 100 may suppress occurrence of unnecessary processing following the generation of the source code candidate for the unnecessary second code.

The code generation unit 130 may perform at least one of specialization of a type of the variable in each of the plurality of source code candidates or specialization of a value of the element of the sparse matrix, based on information that indicates a value range of each of the plurality of variables.

Thus, the information processing apparatus 100 may increase a possibility of speeding up the sparse matrix processing using the finally obtained source code. The sparse matrix specialization information 250 is an example of the information that indicates the value range of each of the plurality of variables.

In the first code and the plurality of second codes, a type of the variable is omitted and the operation expression of a right side of an assignment statement is omitted and written as the function. The expression information includes information on the operation expression that corresponds to the function. In the converting the plurality of second codes into the plurality of source code candidates, the code generation unit 130 converts the function included in the plurality of second codes into the operation expression, based on the expression information and the data type information.

As described above, as a result of omitting the data type and the specific information of the right side expression in the first code and the second codes obtained based on the first code, generation of the source code performed by the information processing apparatus 100 may be made more generic. For example, even if the data type used in the sparse matrix or the format of the right side of the assignment statement is changed, the information processing apparatus 100 may easily obtain the effect of the loop optimization using the convex polyhedral model by preparing the expression information or the data type information in accordance with this format.

The plurality of second codes include a description that indicates the loop processing to be parallelized. In the converting the plurality of second codes into the plurality of source code candidates, the code generation unit 130 inserts a parallelization instruction statement for loops that correspond to the loop processing to be parallelized in the plurality of source code candidates.

Thus, the information processing apparatus 100 may appropriately instruct a compiler of positions of the loops determined to be parallelizable through the convex polyhedral optimization.

The optimized program selection unit 140 selects a source code candidate of which an indicator that indicates the processing performance is higher than a reference value as the final source code from among the plurality of source code candidates, and outputs the selected source code.

Thus, the information processing apparatus 100 may narrow down source code candidates for which improved processing performance is highly likely to be expected for the sparse matrix that is actually set as the processing target. Examples of the indicator of the processing performance include, for example, an execution time of processing on the sparse matrix. For example, the optimized program selection unit 140 may select a source code candidate of which the execution time is shorter than a reference value (threshold) as the finally output source code.

Information processing according to the first embodiment may be implemented by causing the processing unit 12 to execute a program. Information processing according to the second embodiment may be implemented by causing the CPU 101 to execute a program. The program may be recorded on the computer-readable recording medium 73.

For example, the program may be distributed by distributing the recording medium 73 on which the program is recorded. The program may be stored in another computer and distributed via a network. For example, the computer may store (install) the program recorded in the recording medium 73 or received from the other computer in a storage device such as the RAM 102 or the HDD 103, read the program from the storage device, and execute the program.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a program for generating a source code that indicates processing on a sparse matrix and for causing a computer to execute a process, the process comprising:
acquiring a plurality of second codes by optimizing, with a convex polyhedral model, a first code in which loop processing on a matrix is written in a static control part format;
converting the plurality of second codes into a plurality of source code candidates, based on sparse matrix information that indicates a variable that represents a non-zero element of the sparse matrix, expression information that indicates an operation expression that corresponds to a function included in the second codes, and data type information that indicates a type to be used for the variable; and
selecting the source code from among the plurality of source code candidates in accordance with evaluation of processing performance for the sparse matrix in a case where each of the plurality of source code candidates is used.

2. The non-transitory computer-readable recording medium according to claim 1, wherein
the sparse matrix information includes information that indicates a dependency relationship between a plurality of variables that are used in the source code in accordance with a representation format of the sparse matrix and that include a first variable that indicates an index for controlling the loop processing, a second variable that indicates a row number in the sparse matrix, and a third variable that indicates a column number in the sparse matrix, and
in the converting the plurality of second codes into the plurality of source code candidates, a description of the loop processing included in the plurality of second codes is converted into a code that uses the plurality of variables, based on the sparse matrix information.

3. The non-transitory computer-readable recording medium according to claim 2, the process further comprising:
determining whether or not each of the plurality of second codes is usable for the sparse matrix information, based on the dependency relationship between the plurality of variables and a loop structure included in a corresponding one of the plurality of second codes, and converting the second code determined to be usable into a source code candidate.

4. The non-transitory computer-readable recording medium according to claim 2, the process further comprising:
performing, based on information that indicates a value range of each of the plurality of variables, at least one of specialization of a type of the variable or specialization of a value of the element of the sparse matrix in each of the plurality of source code candidates.

5. The non-transitory computer-readable recording medium according to claim 1, wherein
in the first code and the plurality of second codes, a type of the variable is omitted and the operation expression of a right side of an assignment statement is omitted and written as the function,
the expression information includes information on the operation expression that corresponds to the function, and
in the converting the plurality of second codes into the plurality of source code candidates, the function included in the plurality of second codes is converted into a code of the operation expression, based on the expression information and the data type information.

6. The non-transitory computer-readable recording medium according to claim 1, wherein
the plurality of second codes include a description that indicates the loop processing to be parallelized, and
in the converting the plurality of second codes into the plurality of source code candidates, a parallelization instruction statement is inserted for loops that correspond to the loop processing to be parallelized in the plurality of source code candidates.

7. The non-transitory computer-readable recording medium according to claim 1, wherein
in the selecting the source code, a source code candidate of which an indicator that indicates the processing performance is higher than a reference value is selected as the source code from among the plurality of source code candidates.

8. An information processing method comprising:
acquiring a plurality of second codes by optimizing, with a convex polyhedral model, a first code in which loop processing on a matrix is written in a static control part format;
converting the plurality of second codes into a plurality of source code candidates, based on sparse matrix information that indicates a variable that represents a non-zero element of sparse matrix, expression information that indicates an operation expression that corresponds to a function included in the second codes, and data type information that indicates a type to be used for the variable; and
selecting source code, which indicates processing on the sparse matrix, from among the plurality of source code candidates in accordance with evaluation of processing performance for the sparse matrix in a case where each of the plurality of source code candidates is used.
